(19) United States
(12) Patent Application Publication
(10) Pub. No.: US 2007/0227332 A1
(43) Pub. Date: Oct. 4, 2007

(54) AUTOMATIC PATTERN MAKING APPARATUS

(75) Inventors: Lisa D. Causse, Phoenix, AZ (US); Henry Gordon Minns JR., Cave Creek, AZ (US); Kathleen George, Phoenix, AZ (US); Bill Marmaduke, Scottsdale, AZ (US); Brett W. Nordin, Scottsdale, AZ (US); Morten Lassen, Frederiksberg, AZ (US); Joon Park, Seoul (KR); Raymond R. Rivera, Scottsdale, AZ (US); Lawrence Dues, Dublin, OH (US); Jason Pfaff, Phoenix, AZ (US)

Correspondence Address: PILLSBURY WINTHROP SHAW PITTMAN, LLP, P.O. BOX 10500, MCLEAN, VA, 22102, US

(73) Assignee: Xyron, Inc., Scottsdale, AZ (US)

(21) Appl. No.: 11/670,151

(22) Filed: Feb. 1, 2007

Related U.S. Application Data
(63) Continuation-in-part of application No. 11/272,295, filed on Nov. 14, 2005.
(60) Provisional application No. 60/627,179, filed on Nov. 15, 2004.
(60) Provisional application No. 60/763,888, filed on Feb. 1, 2006.
(60) Provisional application No. 60/886,767, filed on Jan. 26, 2007.

(51) Int. Cl. B26D 3/08

(52) U.S. Cl. 83/879; 83/881

(57) ABSTRACT

An automatic paper cutting apparatus includes an X-Y cutter, a cutter controller, and a pattern booklet. The pattern booklet includes a plurality of pattern identifiers and a memory device with cutting instructions for each of the identified patterns. The booklet removably mounts to the cutter controller so that an operator can select a pattern from the pattern booklet and have the memory device provide the corresponding set of cutting instructions to the cutter controller. The cutter controller uses the instructions to control the X-Y cutter and cut the desired pattern. A cutting platform of the X-Y cutter has a tacky adhesive that releaseably secures a work piece to the cutting platform during cutting operations. The cutting platform includes surface features that engage a spur gear. The cutter controller selectively rotates the spur gear to drive the cutting platform in the Y direction. The apparatus may use a journaling, embossing, perforating instrument instead of the cutter to make a pattern on the work piece.

### CROSS REFERENCE

This application is a continuation-in-part of U.S. Utility application Ser. No. 11/272,295, titled “Automatic Pattern Making Apparatus,” filed Nov. 14, 2005, which claims the benefit of priority from U.S. Provisional Application No. 60/627,179, titled “Automatic Pattern Making Apparatus,” filed Nov. 15, 2004. This application also claims the benefit of priority from U.S. Provisional Application No. 60/763,888, titled “Automatic Pattern Making Apparatus,” filed Feb. 1, 2006. This application also claims the benefit of priority from U.S. Provisional Application No. 60/886,767, titled “Automatic Pattern Making Apparatus,” filed Jan. 26, 2007. The entire contents of all of these applications are incorporated herein by reference.

### BACKGROUND OF THE INVENTION

1. Field of the Invention

One invention relates to automatic X-Y cutters that cut patterns out of substantially planar work pieces such as paper. Another invention relates to a cutting mat.

2. Description of Related Art

It is known in the art to provide computer controlled X-Y cutters (see, e.g., U.S. Pat. Nos. 5,388,488 and 3,805,650). However, such X-Y cutters must be connected to a computer, rendering the entire apparatus bulky, non-portable, and expensive.

It is also known in the art to provide a set of cutting instructions on a removable floppy disk that is selectively connected to an X-Y cutter to cut a pattern corresponding to the set of cutting instructions (see U.S. Pat. Nos. 5,634,388 and 5,454,287). However, such devices are not user friendly and do not provide a simple way for an operator to choose among a plurality of patterns to be cut or to scale the size of the pattern up or down.

In X-Y cutters, it is known to use vacuum tables (i.e., tables with small suction holes in them) to hold down a work piece during a cutting operation. Unfortunately, such vacuum tables are noisy and expensive.

It is also known in the art to use a die cutter to cut paper patterns. Unfortunately, the operator must purchase a discrete, expensive die for each pattern and size that the operator wishes to make. For example, the operator must purchase 26 different dies just to have capital alphabet letters of a single size and style. Conventional die cutters also tend to be heavy and bulky because a large amount of force must be exerted on the die to punch through the paper.

### SUMMARY OF THE INVENTION

Accordingly, one aspect of one or more embodiments of this invention provides an automatic pattern cutting apparatus that is self-contained and portable, and allows a plurality of different patterns to be quickly and easily selected and cut or processed from a work piece such as paper.

Another aspect of one or more embodiments of the present invention provides a cutting/processing mat for manual or automatic cutting/processing that releaseably secures the work piece in place during the pattern making procedure, and subsequently releases the produced pattern without harm. The cutting/processing mat is inexpensive, simple, and quiet.

Another aspect of one or more embodiments of the present invention provides a method of creating a pattern selection system for use with a pattern making apparatus. The method includes obtaining electronic data including (a) image data for a plurality of pattern identifiers, and (b) a plurality of sets of pattern making instructions corresponding to the plurality of pattern identifiers, the sets of pattern making instructions being usable by the pattern making apparatus for making patterns corresponding to the pattern identifiers. The method also includes loading the plurality of sets of pattern making instructions onto a memory device readable by the pattern making apparatus, and applying the plurality of pattern identifiers onto a substrate using the image data. Each pattern identifier on the substrate is associated with its corresponding set of pattern making instructions on the memory device.

According to a further aspect of one or more of these embodiments, obtaining the electronic data comprises using software on a computer to generate the electronic data. Additionally and/or alternatively, obtaining the electronic data comprises downloading the image data for the plurality of pattern identifiers over a communication network, and deriving the plurality of sets of pattern making instructions from the image data for the plurality of pattern identifiers, or vice versa. Obtaining the electronic data may include downloading the electronic data over a communication network or from a portable storage device.

According to a further aspect of one or more of these embodiments, the method includes physically assembling the substrate and the memory device. Additional substrates may also be created and assembled with the memory device as well to provide additional available patterns.

According to a further aspect of one or more of these embodiments, the position of each pattern identifier on the substrate associates that pattern identifier with its corresponding set of pattern making instructions on the memory device.

According to a further aspect of one or more of these embodiments, the plurality of sets of pattern making instructions comprise a plurality of pattern cutting instructions.

According to a further aspect of one or more of these embodiments, the method includes operatively connecting the substrate and memory device to a pattern making apparatus for making patterns on a substantially planar work piece. The pattern making apparatus includes a housing; a work piece supporting platform mounted to the housing, the platform being constructed and arranged to support the substantially planar work piece; a pattern making instrument constructed to interact with the work piece, the instrument and the platform being movable relative to one another in generally orthogonal X and Y directions, and in a Z direction generally orthogonal to the X and Y directions; a controller operatively connected to at least one of the instrument and the platform to move the instrument and platform relative to one another in the X, Y, and Z directions; and an operator interface operatively connected to the controller, the operator interface including a set of switches. Operatively connecting the substrate and memory device to the pattern making apparatus includes operatively connecting the memory device to the controller, each set of pattern making instructions being useable by the controller for moving the instrument and platform relative to one another for making a corresponding pattern from the work piece, and operatively connecting the substrate to the operator interface so that predetermined switches of the operator interface are associated with predetermined pattern identifiers on the substrate and their corresponding sets of pattern making instructions in the memory device.

According to a further aspect of one or more of these embodiments, operatively connecting the substrate to the operator interface comprises removably overlaying the substrate onto the operator interface such that each of the plurality of pattern identifiers is physically associated with a corresponding switch.

According to a further aspect of one or more of these embodiments, the method includes selecting a plurality of pattern identifiers from a collection of available patterns. Obtaining the electronic data comprises downloading data associated with the selected plurality of pattern identifiers via a communication network. The method may also include choosing desired pattern identifiers from the plurality of pattern identifiers for which associated data was downloaded. Applying the plurality of pattern identifiers onto the substrate comprises applying the plurality of pattern identifiers associated with the chosen desired pattern identifiers onto the substrate.

According to a further aspect of one or more of these embodiments, the method includes selecting an order for the selected plurality of pattern identifiers to appear on the substrate. Applying the plurality of pattern identifiers onto the substrate comprises applying the plurality of pattern identifiers onto the substrate such that the plurality of pattern identifiers are arranged in the selected order.

According to a further aspect of one or more of these embodiments, a pattern associated with one of the pattern identifiers comprises a plurality of sub-patterns, and wherein applying the plurality of pattern identifiers onto the substrate comprises applying a plurality of pattern identifiers associated with the plurality of sub-patterns adjacent each other on the substrate. The method may also include applying onto the substrate adjacent the plurality of sub-patterns indicia identifying the pattern and the sub-patterns that collectively form the pattern.

Another aspect of one or more embodiments of this invention provides a computer program for carrying out one or more of the above embodiments.

Another aspect of one or more embodiments of this invention provides a pattern cutting apparatus for cutting patterns out of a substantially planar work piece. The apparatus includes a housing; a platform supported by the housing; and a cutting mat supported by the platform. The cutting mat includes a substrate and a first adhesive layer disposed between the substrate and the platform. The first adhesive layer releasably mounts the cutting mat to the platform to enable the cutting mat to be detached from and repositioned relative to the apparatus. The mat also includes a second adhesive layer disposed on an opposite side of the substrate from the platform, the second adhesive layer being constructed and arranged to hold the work piece in a fixed position relative to the substrate while a pattern is cut from the work piece, the second adhesive layer being formed of a repositionable adhesive for releasing the work piece without damage after cutting. The apparatus also includes a cutter supported by the housing, the cutter and cutting mat being movable relative to one another in three orthogonal directions. The apparatus also includes a controller operatively connected to at least one of the cutter and cutting mat to move the cutter and cutting mat relative to one another in the three orthogonal directions. The first adhesive layer may have a higher tack than the second adhesive layer. A protective layer may be removably attached to an exposed surface of the second adhesive layer. The substrate may comprise vinyl or plastic. The mat may include at least one registration mark for guiding the placement of the work piece thereon.

Another aspect of one or more embodiments of this invention provides a work piece supporting mat for securing a substantially planar work piece while making one or more patterns from the work piece. The mat includes a substrate; an upper adhesive layer mounted to the substrate, the upper adhesive layer being formed of a repositionable adhesive for releasably holding the work piece in a fixed position thereon while a pattern is made from the work piece; an upper protective layer removably attached to an exposed surface of the upper adhesive layer; a lower adhesive layer mounted to the substrate, the lower adhesive layer being a repositionable adhesive for releasably holding the mat in a fixed position on a surface against which the mat is mounted; and a lower protective layer removably attached to an exposed surface of the lower adhesive layer. The lower adhesive layer may have a higher tack than the upper adhesive layer. A self-healing layer may be disposed between the substrate and the upper adhesive layer.

Another aspect of one or more embodiments of this invention provides a pattern cutting apparatus for cutting patterns out of a substantially planar work piece. The apparatus includes a housing and a cutting mat supported by the housing. The cutting mat includes a substrate, a self-healing layer disposed on the substrate, and an adhesive layer disposed on the self-healing layer, the adhesive layer being constructed and arranged to hold the work piece in a fixed position relative to the substrate while a pattern is cut from the work piece, the adhesive layer being formed of a repositionable adhesive for releasing the work piece without damage after cutting. The apparatus also includes a cutter supported by the housing, the cutter and cutting mat being movable relative to one another in three orthogonal directions. The apparatus also includes a controller operatively connected to at least one of the cutter and cutting mat to move the cutter and cutting mat relative to one another in the three orthogonal directions.

Another aspect of one or more embodiments of this invention provides a pattern cutting apparatus for cutting patterns out of a substantially planar work piece. The apparatus includes a housing; a work piece supporting platform; and a cutter assembly supported by the housing. The cutter assembly includes a cutter carrier having a work piece contacting surface, the cutter carrier being resiliently biased toward the platform for maintaining the work piece contacting surface in contact with the work piece and for enabling the cutter carrier to move upwardly when the work piece contacting surface engages raised portions of the work piece, and a cutter extending beyond the work piece contacting surface by a predetermined distance, the cutter assembly and platform being movable relative to one another in three orthogonal directions. The apparatus also includes a controller operatively connected to at least one of the cutter assembly and platform to move the cutter assembly and platform relative to one another in the three orthogonal directions.

According to a further aspect of one or more of these embodiments, the cutter assembly further comprises a resilient member that biases the cutter carrier toward the platform.

According to a further aspect of one or more of these embodiments, the cutter carrier is positioned and arranged such that cutter carrier and cutter move away from the platform in response to a predetermined force being applied to the work piece contacting surface and cutter.

According to a further aspect of one or more of these embodiments, the cutter carrier is positioned and arranged such that cutter carrier and cutter move away from the platform by at least 0.1 mm in response to the predetermined force being applied to the work piece contacting surface and cutter.

According to further aspects of one or more of these embodiments, the predetermined force may be less than 15.0 N, 10.0 N, 8.0 N, 6.0 N, 5.0 N, 4.0 N, and/or 3.0 N.

According to a further aspect of one or more of these embodiments, the controller comprises a linear actuator that operatively extends between the housing and the cutter carrier to selectively move the cutter carrier between cutting and non-cutting positions. The resilient member operatively extends between the linear actuator and the cutter carrier for biasing the cutter carrier toward the platform when the cutter carrier is in the cutting position.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which from a part of this original disclosure:

FIGS. 1-3 are perspective views of a pattern cutting apparatus according to one embodiment of the present invention;

FIG. 4 is a partial cross-sectional view of a cutting mat of the pattern cutting apparatus of FIG. 1;

FIG. 5 is a partial cross-sectional view of a cutting mat for manual cutting according to an alternative embodiment of the present invention;

FIG. 6 is a perspective view of an operator interface of the pattern cutting apparatus shown in FIG. 2;

FIG. 7 is a perspective view of a pattern booklet for the pattern cutting apparatus of FIG. 1;

FIG. 7A is a perspective view of a pattern booklet for the pattern cutting apparatus of FIG. 1 according to an alternative embodiment of the present invention;

FIG. 8 is a block diagram of the pattern cutting apparatus of FIG. 1;

FIG. 9 is an exploded view of a cutting assembly according to an embodiment of the present invention;

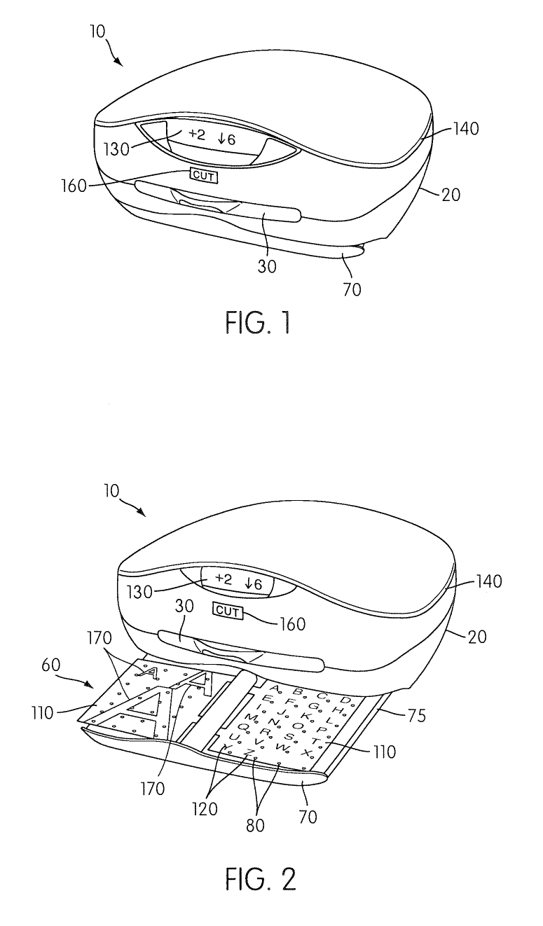

FIG. 1O is a perspective view of a pattern booklet for the pattern cutting apparatus of FIG. 1 according to an alternative embodiment of the present invention;

FIG. 11 is a perspective view of a pattern making apparatus according to an alternative embodiment of the present invention;

FIG. 12 is a perspective view of a work piece supporting platform of the apparatus illustrated in FIG. 11;

FIG. 13 is a rear, partial, perspective view of the apparatus illustrated in FIG. 1;

FIG. 14 is a flowchart illustrates a method for making a pattern according to an embodiment of the present invention;

FIGS. 15A and 15B are perspective and side views, respectively, of a cutter for use with the apparatus of FIG. 1 according to an embodiment of the present invention;

FIGS. 16A and 16B are perspective and side views, respectively, of a journaling instrument for use with the apparatus of FIG. 1 according to an embodiment of the present invention;

FIGS. 17A and 17B are perspective and side views, respectively, of an embossing instrument for use with the apparatus of FIG. 1 according to an embodiment of the present invention;

FIGS. 18A and 18B are perspective and side views, respectively, of a perforating instrument for use with the apparatus of FIG. 1 according to an embodiment of the present invention:

FIG. 19 is a partial cross-sectional view of an embossing mat for use with the apparatus of FIG. 1 according to an embodiment of the present invention;

FIG. 20 illustrates the use of the embossing mat of FIG. 19;

FIG. 21 is a flowchart illustrating the creation of a pattern booklet for use with the apparatus of FIG. 1;

FIG. 22 is a perspective view of a floating cutter assembly according to an alternative embodiment of the present invention;

FIG. 23 is a partial cross-sectional, exploded view of the floating cutter assembly of FIG. 22;

FIG. 24 is a cross-sectional view of a cutting mat according to an alternative embodiment of the present invention;

FIG. 25 is a partial cross-sectional view of the operation of the floating cutter assembly of FIG. 22; and

FIGS. 26-31 are screen shots illustrating the use of a software program for designing and creating a pattern booklet for use with the apparatus of FIG. 1.

### DETAILED DESCRIPTION OF PREFERRED EMBODIMENTS

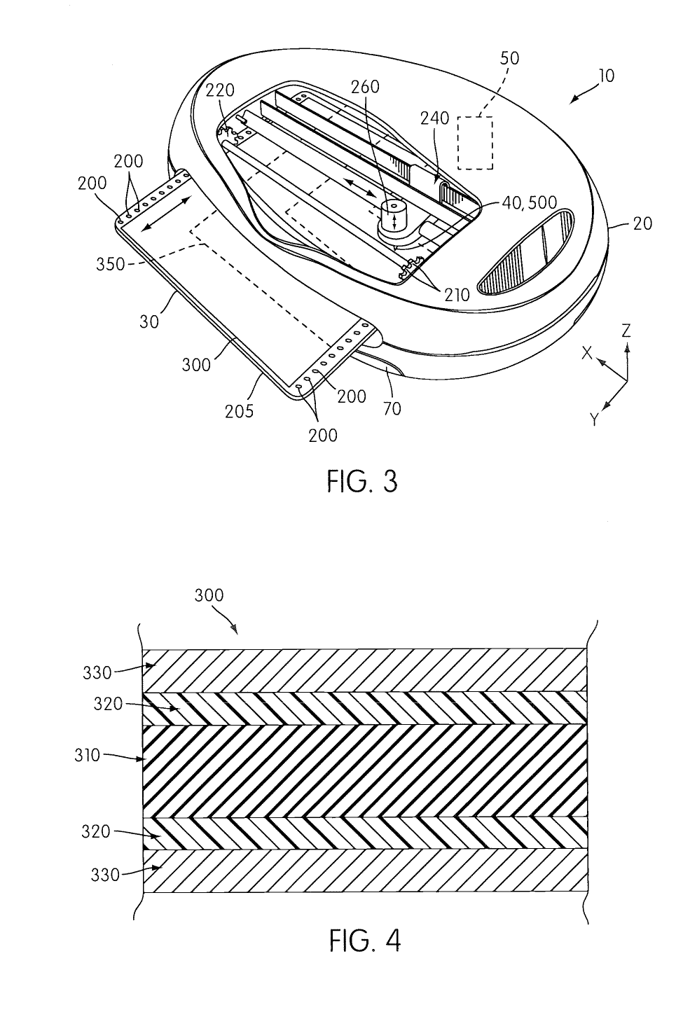

FIGS. 1-3 illustrate an automatic pattern cutting apparatus 10 according to one embodiment of the present invention. The apparatus 10 comprises a housing 20, a cutting/work piece supporting platform 30 mounted to the housing 20, and a work piece cutter 40 (see FIG. 3). The cutter 40 is movably mounted to the housing 20 to permit the cutter 40 to move relative to the cutting platform 30 in generally orthogonal X and Z directions, and the platform 30 is movable relative to the cutter 40 in a Y direction, which is generally orthogonal to both the X and Z directions. A cutter controller 50 operatively connects to the cutter 40 and the platform 30 to move the cutter 40 and the platform 30 relative to one another in the X, Y, and Z directions. The platform 30, cutter 40, and cutter controller 50, as well as alternative constructions, are discussed later in the application. The apparatus 10 also includes an interchangeable pattern booklet 60 (see FIG. 2) that removably engages an operator interface 70 and the cutter controller 50.

While the illustrated apparatus 10 utilizes a cutter 40 to make patterns in the work piece, alternative pattern making instruments may replace the cutter 40 to interact with the work piece. For example, the cutter 40 may be replaced with pattern making instruments such as a journaling instrument (e.g., pen, pencil, chalk, calligraphy pen, etc.), an embossing instrument, a scoring instrument, or a perforating instrument. If a journaling instrument is used, the apparatus 10 can draw patterns on the work piece. The operator may use these drawn or embossed patterns on the work piece as is, or may manually cut the pattern out of the work piece by using the drawn or embossed pattern as a guide.

As shown in FIGS. 1, 2, and 6, the operator interface 70 comprises a tray 75 that permanently slidably mounts to the housing 20 so that the operator interface may be selectively opened to allow an operator to operate the apparatus 10 (see FIG. 2) or closed to facilitate storage and transport of the apparatus 10 (see FIG. 1). As shown in FIG. 6, the operator interface 70 comprises a set of operator-actuated switches 80 arranged in a two-dimensional array on an upper surface of the tray 75 of the operator interface 70. The switches 80 are operatively connected to the cutter controller 50 to indicate to the cutter controller 50 when any switch 80 is actuated. The switches 80 may comprise any type of suitable operator-actuated switches. The illustrated switches 80 comprise pressure sensitive momentary switches that are disposed below a flexible liner on the operator interface 70. These are often referred to as membrane switches. Alternatively, the switches 80 may comprise momentary switches that extend upwardly from the top of the operator interface 70, which may use depressible buttons. Alternatively, the upper surface of the operator interface 70 may be proximity-sensitive or touch-sensitive (such as by capacitive sensing, or some other means) and indicate to the cutter controller 50 what region of the operator interface 70 is actuated. While the illustrated operator interface 70 slidably mounts to the housing 20, the operator interface 70 may alternatively rigidly or pivotally mount to the housing 20 without deviating from the scope of the present invention.

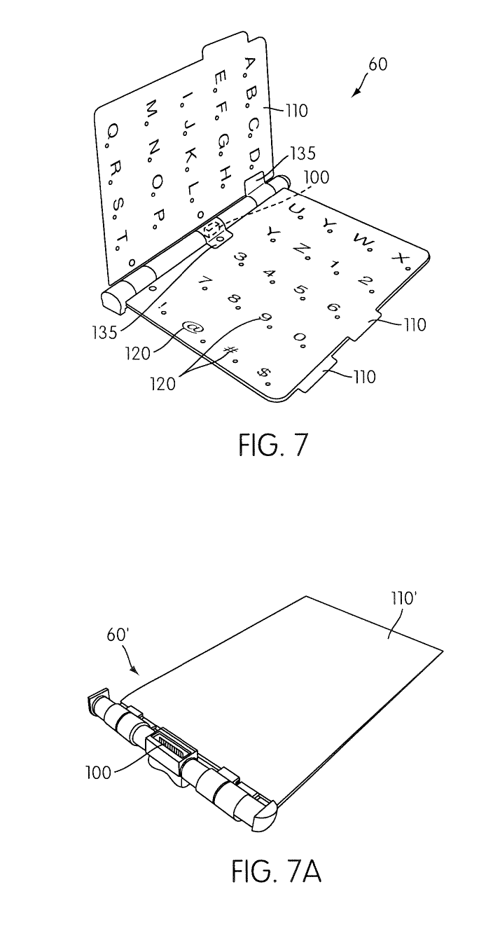

As shown in FIG. 7, the pattern booklet 60 comprises a memory device 100 and a plurality of pages 110 of pattern identifiers 120. The pages 110 may comprise any suitable type of substrate (e.g., paper, plastic, cardstock, cardboard, etc.) and shape (square, oval, rectangular, irregularly curved and/or angled, etc.). While the illustrated pages 110 are connected to each other and to the booklet 60, the pages 100 may alternatively remain discrete stand-alone elements (e.g., a stack of cards, etc.). The pattern identifiers 120 are permanently displayed in two-dimensional sets on each page 110 of the booklet 60. The pattern identifiers 120 may be printed, embossed, glued, etched, stitched, molded, or otherwise applied to the pages 110. The pattern identifiers 120 may include any suitable patterns such as alphabet letters, numbers, geometric patterns, animal patterns, etc. The memory device 100 comprises any suitable memory device such as a flash memory card, ROM memory, a floppy disk, a hard disk drive, etc. The memory device 100 contains a set of cutting (or other pattern making) instructions corresponding to each pattern identified by each pattern identifier 120. The cutter controller 50 selectively reads the memory device 100 to obtain the appropriate set of cutting instructions and control the relative movement between the cutter 40 and the platform 30 to cut a desired pattern.

The patterns and pattern making instructions in the booklet 60 may be designed to make patterns using any one or more different types of pattern making instruments. For example, a single set of pattern making instructions may be used to cut a pattern using the cutter 40, to journal the pattern using a journaling instrument, or to score the pattern using a scoring instrument. Additionally and/or alternatively, pattern booklets 60 (or individual patterns therein) may be specifically designed to make patterns using certain pattern making instruments. For example, certain patterns and pattern making instructions may be specifically designed for use with an embossing instrument or other specific type of pattern making instrument.

As shown in FIGS. 2, 6, and 7, the pattern booklet 60 is selectively and removably mountable to the operator interface 70. When the pattern booklet 60 is mounted to the operator interface 70, the memory device 100 operatively engages a connection port 150 (see FIG. 6) in the operator interface 70, which operatively connects the memory device 100 to the cutter controller 50. Similarly, when the pattern booklet 60 is mounted to the operator interface 70, the pages 110 may be selectively turned such that the set of pattern identifiers 120 on a chosen page 110 physically aligns with the set of switches 80, thereby providing each pattern identifier 120 with an associated switch 80. As shown in FIG. 2, the switches 80 are visible through holes in the pages 110 that are associated with specific pattern identifiers 120. Alternatively, the switches 80 may be disposed below the pattern identifiers 120 so that an operator chooses a pattern by pushing down on the pattern identifier 120 itself, which actuates the switch 80 beneath that pattern identifier 120.

While physical alignment between the illustrated pattern identifiers 120 and switches 80 involves disposing the switches 80 in close physical proximity to the pattern identifiers 120, the switches 80 and pattern identifiers may be physically aligned without such close proximity. For example, a line on the page may run from a pattern identifier 120 to an edge of the page and the associated switch 80 may be disposed adjacent the page 110 and line. Physical alignment merely requires a predetermined spatial link or relationship between the pattern identifier 120 and an associated switch 80 that helps an operator to know which switch 80 is associated with which pattern identifier 120.

While the illustrated pages 110 and pattern identifiers 120 physically align with the set of switches 80 so that each pattern identifier 120 physically corresponds to an associated switch 80, the pattern identifiers 120 may alternatively correspond to the set of switches 80 through a logical, non-spatial relationship. For example, each switch 80 may be numbered. Corresponding numbers could appear next to each pattern identifier 120 in the booklet 60. An operator could peruse the booklet 60, choose a desired pattern and pattern identifier 120, and indicate his/her selection to the apparatus 10 by actuating the correspondingly numbered switch 80. Moreover, in such an alternative, the corresponding switches could comprise a small keypad or other input device that enables the operator to simply type in a number or code corresponding to the pattern identifier 120. Likewise, with any of the above-described embodiments, the memory device 100 could be separate from the booklet 60 and inserted in a port on the apparatus 10, or otherwise engaged with a connector, for allowing the controller 50 to read the appropriate cutting instructions.

In an alternative embodiment, the operator interface 70 comprises a pattern identifier 120 selecting pen/wand. The operator may use the pen/wand to scan a bar code next to a desired pattern identifier 120 in the booklet 60. Alternatively, the operator may place the pen/wand on or near the desired pattern identifier 120 and the pen/wand may sense a corresponding short-range radio frequency ID tag disposed under or near the desired pattern identifier. The pen/wand may interact with the controller 50 via wireless or wired communication to indicate the desired pattern to the controller 50. Generally, any suitable operator interface may be used to allow the operator to select the desired set of instructions for controlling the cutting operation.

While the illustrated operator interface 70 is permanently attached to the housing 20 and removably mountable to the booklet 60, the operator interface 70 may alternatively be incorporated into the booklet 60, itself, such that the operator interface 70, memory device 100, and pages 110 are assembled together into the booklet 60. In such an embodiment, the switches 80 could be disposed beneath the pattern identifiers 120 on the pages 110 or between sandwiched layers of each page 110. The booklet 60 is removably mountable to the housing 20 with the operator interface 70 being operatively connectable to the cutter controller 50 through a port similar to the port 150 for the memory device. Alternatively, because the operator interface 70 is in the booklet 60, the memory device 100 and operator interface 70 may be connected to the cutter controller 50 by other means, such as by a connector cable (e.g., a USB cable) or by a wireless transmitter/receiver connection (e.g., an infrared connection or BLUETOOTH connection). In such alternatives, there is no need for providing a tray 75 or other structure for mounting the booklet 60 to the housing 20.

As shown in FIG. 6, an array of page sensors 125 are disposed on the operator interface 70 to sense which page 110 of the booklet 60 is face up (i.e., viewed by the operator). The sensors 125 operatively connect to the cutter controller 50 to identify the face up page 110 so that the cutter controller 50 uses the sets of cutting instructions on the memory device 100 that correspond to the pattern identifiers 120 on that face up page 110. As shown in FIG. 7, tabs 135 connect each page 110 to the spine of the booklet 60. These tabs 135 align with the sensors 125 such that the sensors 125 sense which page 110 is face up.

In the illustrated embodiment, the sensors 125 comprise light sensors that sense whether a tab 135 covers the corresponding sensor 125. As shown in FIG. 7, holes are disposed in the leftward pages 110 at page positions that are adjacent to tabs 135 of rightward pages 110 so that the leftward pages do not cover the sensors 125 that correspond to the rightward pages 110. Alternatively, the sensors 135 could align with tabs that extend outwardly from the outer edge of the pages 110.

Although the illustrated sensors 125 comprise light sensors, any other suitable sensor could alternatively be used. For example, the sensors 125 could comprise momentary switches that are actuated when the tabs 135 of the pages 110 are turned and lay on the switches. Alternatively, each sensor 125 may be incorporated into the spine of the booklet 60 so that the sensor senses a pivotal position of each page 110 relative to the spine of the booklet 60. Alternatively, each sensor 125 may be a switch that the operator actuates to indicate which page 110 is open. Alternatively, each sensor 125 may comprise any other type of suitable sensor that is capable of indicating to the cutter controller 50 which page 110 the operator is selecting patterns from.

FIG. 7A is a bottom perspective view of a booklet 60′ according to an alternative embodiment of the present invention. The booklet 60′ is generally similar to the booklet 60 except for the shape of its pages 110′. As in the booklet 60, the booklet 60′ includes the memory device 100 disposed in its spine.

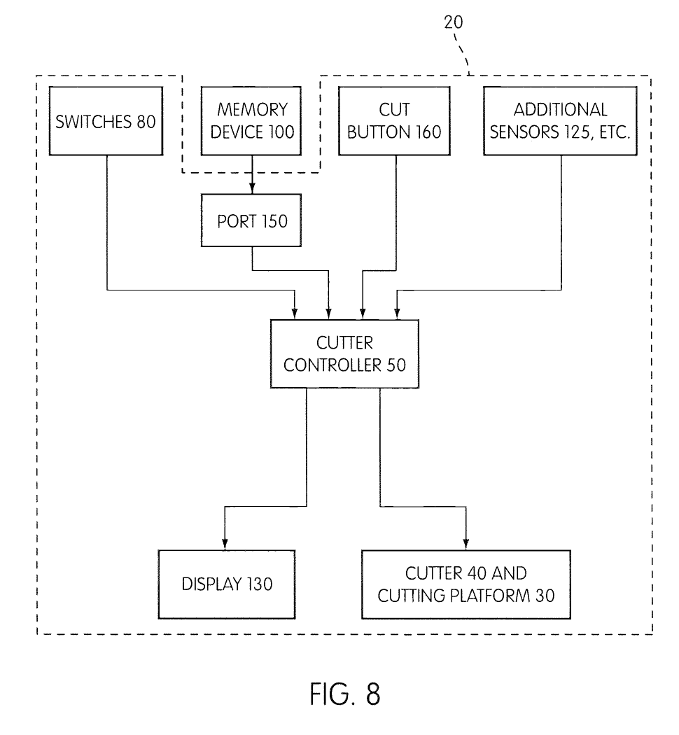

As shown in FIGS. 2 and 8, operator actuation of the switch 80 aligned with a corresponding pattern identifier 120 signals to the cutter controller 50 the pattern desired to be cut. The cutter controller 50 uses the set of cutting instructions on the memory device 100 that corresponds to the associated pattern identifier 120 to control the cutter 40 and/or the platform 30 to cut the desired pattern.

As shown in FIGS. 1, 2 and 8, an LCD display 130 operatively connects to the cutter controller 50. The cutter controller 50 preferably comprises an electronic control unit, such as a microprocessor, that is programmed to perform a plurality of functions of the apparatus 10. The cutter controller 50 displays instructions on the display 130 to help an operator use the apparatus 10. For example, the cutter controller 50 may initially use the display 130 to request that the operator select a desired pattern. The cutter controller 50 may also allow the operator to select additional patterns to be cut from a single work piece, and would make an appropriate determination as to the arrangement of the patterns being cut from the work piece. The cutter controller 50 could calculate work piece usage (i.e., the space available for cutting another pattern) and indicate to the operator using the display 130 when an additional selected pattern will not fit on the work piece. In such a case, the cutter controller 50 may allow the operator to either confirm the already selected pattern(s) or unselect the already selected pattern(s) and start over. The cutter controller 50 may ask the operator via the display to confirm the X and Y dimensions of the work piece to be cut to help the controller 50 determine what patterns will fit onto the work piece.

After the operator has selected all patterns to be cut from a single work piece, the operator actuates a “CUT” button 160 (see FIGS. 1 and 2) on the apparatus 10 that instructs the cutter controller 50 to initiate the cutting procedure. The cutter controller 50 may then indicate to the operator via the display 130 when the cutting procedure is completed. While the illustrated cutter controller 50 utilizes a display to visually communicate with the operator, the cutter controller 50 may alternatively or additionally audibly communicate with the operator through a speaker.

As shown in FIG. 2, the cutter controller 50 allows the operator to chose a size (e.g., ½″, 1″, 2″, and 3″) for each desired pattern by actuating a switch 80 that is associated with one of a plurality of a size identifiers 170 on a page 110 of the booklet 60. Alternatively, separate size-identifying switches/sensors may be mounted to the housing 20 and operatively connected to the cutter controller 50 to enable the operator to choose a pattern size. The memory device 100 may store separate cutting instructions for each size of each pattern. Alternatively, the cutter controller 50 may enlarge or reduce a single set of cutting instructions in the memory device 100 for each pattern to vary the size of the pattern (i.e., a scaling operation).

As shown in FIG. 1, the apparatus 10 includes a movable or removable lid 140 that covers the cutter 40. A lid sensor (not shown) that senses whether the lid 140 is closed may operatively connect to the cutter controller 50. The cutter controller 50 may prevent cutting procedures from starting or continuing if the lid 140 is open. The cutter controller 50 may indicate to the operator via the display 130 that the lid 140 is open and must be closed before the cutter controller 50 can operate the cutter 40.

The lid sensor, as well as other sensors utilized by the apparatus 10, may comprise any type of suitable sensor as would be understood by one of ordinary skill in the art. For example, the lid sensor may comprise an appropriately positioned momentary switch that is physically actuated by the closing of the lid 140. Alternatively, the lid sensor may comprise electrical contacts on the housing and lid that contact each other to complete an electrical circuit when the lid 140 is closed.

The cutter controller 50 may also have various other useful control features and logical functions. These may include an on/off function and/or other control features.

The operator may interact with the cutter controller 50 by actuating appropriate switches 80. Alternatively, the apparatus 10 may also include a discrete keypad connected to the cutter controller 50 that enables the operator to make choices in response to cutter controller 50 instructions on the display 130.

The cutter controller 50 may perform various diagnostic functions at appropriate times during use. For example, if the memory device 100 is not detected or is faulty and cannot be read, the cutter controller may instruct the operator via the display 130 to insert and/or replace the memory device 100. The cutter controller 50 may similarly determine whether a booklet 60 is operatively connected to the apparatus 10.

Additional pattern booklets 60 may be provided with additional patterns and corresponding pattern making instructions so that the apparatus 10 has an even larger selection of patterns. The modular design of the apparatus 10 enables a user to quickly and easily mount other pattern booklets 60 to the operator interface 70 in place of the booklet 60.

As shown in FIGS. 10, 14, and 21, an Internet- or software-based system could be used to enable the end operator to create personalized booklets 60″ by downloading/creating sets of cutting instructions for storage onto a memory device 100″ and corresponding images (i.e., pattern identifiers 120) for printing onto blank pages 110″. FIG. 14 illustrates a method for supplying personalized pattern booklets 60″ to users according to one embodiment of the present invention. FIG. 21 illustrates a corresponding flow of information/components.

At step 700, a user purchases or otherwise obtains a blank booklet 60″. This method may also use a blank page that is not in a booklet.

At step 710, the user attaches the booklet 60″ with blank memory device 100″ to the apparatus 10. At step 720, the user connects the apparatus 10 to a computer via a USB connection 180 (see FIG. 13). Alternatively, the blank memory device 100″ may connect directly to the operator's computer via a direct USB connection (similar to USB flash memory devices) or through a specialized or standard cable designed to connect the memory device 100″ to a computer. The memory device 100″ may detachably connect to the booklet 60″ to facilitate direct connection to a computer. The “blank” memory device 100″ may include a software program that facilitates downloading patterns to the memory device 100″. The memory device 100″ may also be a commercially available storage card, such as a CompactFlash card, SD card, USB flash memory card, etc., that is received in a card reader on or connected to the computer or otherwise connected to the computer. The booklets 60″ could be designed to releasably engage such commercially available memory devices and a port 150″ like the port 150 could be designed to accept such commercially available memory devices when the booklet 60″ is attached to the apparatus 10.

At step 730, the user (on his/her computer or other suitable network access terminal) uses a password to enter a private web site operated on a remote server by the supplier of the booklets 60″ (or other appropriate vendor). The password and private web site enable the user to work within a personalized web environment to create and/or organize the patterns that will be added to the blank booklet 60″. The supplier may provide such a password with each blank booklet 60″ so that the cost of each booklet 60″ includes a charge for downloading patterns to the booklet 60″. Alternatively, the password can be linked to a pattern subscription service such that the supplier charges users for downloading patterns using any suitable payment system (e.g., charge per pattern downloaded, monthly/yearly charge for access to all available patterns, etc.). Alternatively, the supplier's web site could allow anyone to design booklets 60″, but require payment (or an authorizing password) before allowing the design to be downloaded to a user's memory device 100″. Alternatively, the supplier's web site could be free for all users and not require a password.

At step 740, the user creates and organizes the pages 110″ of the booklet 60″ online. This may include choosing which pattern identifiers 120 to include in the booklet 60″ as well as choosing which order the pattern identifiers will be placed on the pages 11O″.

At step 750, the user downloads page 110″ images and prints them onto pages 110″. The program and/or web site may derive images of the pattern identifiers 120 from their associated cutting instructions. At Step 760, the user attaches the pages 110″ to the booklet 60″. As shown in FIG. 10, the pages 110″ may slide into appropriate sheet receiving pockets 190 of the booklet 60″. Alternatively, the booklet 60″ may be designed to attach to pages 110″ using any other suitable fastening technique (e.g., staples, three-ring binder holes, glue, double sided tape, etc.). The chosen fastening technique is preferably designed to result in registration that ensures that each pattern identifier 120 aligns with the appropriate switch 80 on the operator interface 70. The booklet 60″ may include an alignment grid to help users to properly position pages 110″ in the booklet 60″.

At step 770, the user downloads cutting instructions corresponding to the pattern identifiers on the pages 110″ to the memory device 100″. The cutting instructions are correlated to the physical location of the corresponding pattern identifiers 120 on the pages 110″ such that selecting a pattern identifier 120 using the operator interface 70 causes the controller 50 to select the appropriate corresponding set of pattern making instructions from the memory device 100″.

In the above-described embodiment, the design of pages 110″ is conducted online via software run by the supplier's web site and whole page 110″ images are downloaded to the user's computer. Alternatively, this operation could be driven by software on the user's computer or on the memory device 100″ itself, which assembles pattern identifiers and sets of cutting instructions to generate electronic data including the pattern identifiers and corresponding sets of cutting instructions. The software could interact with the supplier's web site to identify available patterns and download specific sets of cutting instructions and pattern identifiers. For example, as shown in the screen print in FIG. 26, a software program 1200 running on the user's computer interacts with the supplier's server to make various patterns 1230 available. As shown in FIG. 26, the supplier's available patterns 1230 are shown within a web site frame (or other component) 1210 within the software program 1200. The user opens the pattern store frame 1210 by selecting it from a menu in another frame of a graphical user interface of the program 1200. After opening the pattern store frame 1210, the user selects desired patterns 1230 by placing them into an online shopping cart. Paying for the selected patterns 1230 in the shopping cart enables the user to download electronic data (e.g., pattern identifiers and/or associated cutting instructions) for the selected patterns 1230 to a pattern library 1220 on the user's computer. However, the pattern library 1220 may alternatively be stored on the supplier's server.

While the illustrated interaction between the program 1200 and supplier's server comprises a web site frame within the program 1200, the user may alternatively obtain patterns 1230 by using a web browser to connect directly to the supplier's web site to purchase patterns 1230. The user may then download purchased patterns 1230 and place them into the library 1220 on the user's computer. The user may alternatively obtain patterns 1230 via other means (e.g., from a CD, flash memory device, etc.).

The user may review the purchased and downloaded patterns 1230 by selecting a pattern library 1220 frame from the menu. FIG. 27 is a screenshot of the program 1200 showing the library 1220 of downloaded patterns 1220 that are available for use in the user-created booklet 60″. The library 1220 may display various details about each pattern 1230 (e.g., pattern identifier, date acquired, date downloaded, size of the electronic data (e.g., amount of free space required on the memory device 100″ for the cutting instructions).

The patterns 1230 may comprise a plurality of sub-patterns 1240 that together create the pattern 1230 that is assembled post-cutting. For example, as shown in FIG. 27, a pattern 1230 of a car includes sub-patterns 1240 for the headlights, body, lower body, tires, and wheels of the car. The use of differently colored or textured work pieces 1080 for different sub-patterns 1240 of the pattern 1230 facilitates more elaborate patterns. The library 1220 may also indicate how many sub-patterns and positions 1280 (explained below) on the page 110″ the pattern 1230 will occupy. For example, the car shown in FIG. 27 comprises five sub-patterns 1240, which occupy 5 “keys” or switches on the page 110″. An explanation of the car pattern 1230 and its associated sub-patterns 1240 occupy an additional 3 positions 1280 on the page 110″ such that the car pattern occupies a total space on the page 110″ of 2 positions by 4 positions (i.e., eight positions that include 3 explanatory positions and 5 sub-pattern positions).

As shown in FIGS. 28-31, the user then selects patterns from the library 1220 and chooses how to lay the patterns 1230 out on the pages 60″. FIGS. 28-31 represent sequential screen prints from the use of a design layout component 1260 of the program 1200 showing the sequential design of a booklet 60″. As shown in FIG. 28, the user initially selects the design layout component 1260 from the menu. The book design frame illustrates the available positions on a selected page 110″ of the booklet 60″. In the illustrated example, each page comprises 56 positions 1280 (8 columns having seven positions each). The final four positions are taken up by scaling positions 1270 associated with scaling switches for scaling the size of a pattern 1230 and a cancel position 1290 associated with a switch for canceling previously selected pattern(s) 1230.

As shown in FIG. 29, the user selects a pattern 1230 (a flower in the illustrated embodiment) from the library 1220, which is shown at the bottom of the design layout component 1260. A box 1300 pops up showing the positions that the pattern 1230 will occupy on the page 110″. In the illustrated example, the flower occupies two rows of four positions each (i.e., “2×4”). As shown in FIG. 30, the user moves the box 1300 to a desired location on the page 110″ with sufficient free space and accepts the positioning. Alternatively, the design layout component 1260 may automatically move the box 1300 into the next available position following a predetermined order (e.g., filling positions 1280 in sequential order from left to right across each row before moving to the next row). The user repeats this process for additional patterns 1230 to be placed on the page 110″. The boxes 1300 may have rigid shapes (rigid 2 rows by 3 columns), or may flexibly fit into the available free space (e.g., fitting into the next available positions, converting from 2 rows by 3 columns into 2 columns by 3 rows). For example, the flowers shown in the lower left part of the page 110″ layout in FIG. 31 occupy a row of 2 positions 1280 and a row of four positions 1280 in order to fit into the available 6 positions at the bottom left side of the page 110″.

As shown in FIG. 30, the program 1200 may add reference numbers to the sub-patterns 1240 such that the description of the pattern 1230 specifically identifies which sub-patterns 1240 make up the pattern 1230.

The user can then repeat this process to create additional page 110″ layouts for inclusion in a booklet 60″. For example, as shown in FIG. 30, three previous pages 110″ are already present, page 3 of which is shown in detail in FIG. 31. The design layout component 1260 may enable a user to save partially completed booklet layouts for later completion.

After the user finalizes the booklet 60″ layout, the user may instruct the program 1200 to print the pages 110″ and download the cutting instructions from the user's computer to the memory device 100″. A printing component of the program 1200 creates a page 110″ image by positioning the pattern identifiers for the patterns 1230 and sub-patterns 1240 in appropriate positions so that the pattern identifiers 120 will be associated with corresponding switches 80 of the operator interface 70 when the booklet 60″ is operatively connected to the apparatus 10. The page 110″ image may then be printed onto a substrate (e.g., paper) that forms pages 110″ of the booklet 60″. Each page 110″ may then be attached to the blank booklet 60″ in the correct order (e.g., by trimming the edges of the page 110″ along dotted lines printed by the printing component and then slipping the page 110″ into a transparent pocket in the blank booklet 60″, gluing each page 110″ to a page of the blank booklet 60″, etc.). The program 1200 also downloads the cutting instructions to the memory device 100″ in such a way that the cutting instructions are associated with the corresponding patent identifiers 120. Consequently, cutting instructions for each pattern 1230 or sub-pattern 1240 are associated with a position 1280 on a page 110″ of the booklet 60″ such that when a switch 80 associated with that position 1280 is actuated, the apparatus 10 uses the set of cutting instructions associated with the pattern identifier 120 on at that position 1280 to cut the selected pattern 1230 or sub-pattern 1240.

The program 1200 may allow the user to repeatedly use a downloaded pattern 1230 in different booklets 60″. Alternatively, the program 1200 may allow the user to place a downloaded pattern in multiple booklet layouts, but only permit the pattern 1230 to be printed to a page 110″ and downloaded to a memory device 100″ once. In such an embodiment, the user must repurchase a pattern 1230 from the supplier to use it a second time.

The program 1200 may also enable a user to pull patterns 1230 back from a previously created booklet 60″ by connecting the memory device 100″ to the computer, deleting the pattern 1230 from the memory device 100″, and placing the pattern 1230 back into the library 1220 of available patterns 1220.

In the above-described embodiment, the program 1200 obtains patterns from the supplier's server via a communications network. Alternatively, as shown in FIG. 21, the software could obtain sets of cutting instructions and pattern identifiers from a portable storage device (e.g., diskette, CD, DVD, flash memory, etc.) attached to the user's computer instead of downloading them from a remote computer via the Internet.

Additionally and/or alternatively, the software and/or web site may enable a user to design his/her own patterns. The program or web site would then create corresponding pattern making instructions based on the user-created pattern.

In the above described embodiment, pattern identifiers 120 and sets of cutting instructions are downloaded as separate files. Alternatively, both the pattern identifiers and the cutting instructions may be downloaded as a single file. For example, the software could derive the cutting instructions from the downloaded image data for the associated pattern identifier 120 (or vice versa). Conversely, the software could derive the image data for the pattern identifiers 120 from their associate cutting instructions. Any suitable software may be used for deriving vector data for the cutting instructions from the line/image data of the pattern identifiers or vice versa.

The booklets 60″ may be single-use booklets that only permit patterns to be downloaded onto the memory device 100″ once. Software or other suitable mechanisms in the memory device 100″ or elsewhere can be used to prevent additional downloads to the booklet 60″. Alternatively, the booklets 60″ may be reusable, such that the user can create entire new combinations of patterns by downloading new instructions to the memory device 100″ and adding new pages 110″ to the booklet 60″.

The provision of such a large number of possible patterns and pattern sizes on the pages 110, 110″ of the booklet 60, 60″ and memory device 100, 100″ presents a substantial improvement over conventional die-based cutters, whose repertoire of patterns and sizes is limited to the available discrete dies. In contrast, a large number of patterns and cutting instructions can be stored in the memory device 100, 100″ and pages 110, 110″ of a single compact booklet 60, 60″ of the apparatus 10.

The controller 50 may be upgraded/updated in any suitable manner to improve/expand the functionality of the controller 50. For example, software updates may be provided to the controller 50 via a memory device 100 with such updates stored thereon. An update may be transferred to the memory device 100 from a separate computer that obtains the update electronically. Alternatively, the controller 50 may connect directly to the computer via a suitable connection (e.g., serial connection, USB connection 180 (shown in FIG. 13), infrared connection, Bluetooth connection, WIFI, etc.) and obtain updates directly from the computer. Alternatively, the apparatus 10 may include telephone/modem ports, Ethernet ports, or other network or communication connections and associated networking hardware that enables the controller 50 to directly obtain updates over a communication network (e.g., Internet, telecommunications network, bulletin board system, etc.). Such communications connections may also be used to obtain additional patterns and pattern making instructions from a geographically distant source (e.g., an internet web site; a networked computer, etc.). The memory device 100″ may also use any of the above techniques to download pattern making instructions.

Operation of the cutter 40 is described hereinafter with reference to FIG. 3.

As shown in FIG. 3, the cutting platform 30 comprises a substantially flat, rigid platform that extends in X and Y directions and is movable relative to the housing 20 and cutter 40 in the Y direction. Alternatively, the platform 30 may be flexible without deviating from the scope of the present invention. A plurality of surface features 200 extend linearly in the Y direction along the outside edges of a rigid substrate 205 of the cutting platform 30. The surface features 200 engage corresponding surface features 210 on a motorized wheel or spur gear 220 such that rotation of the wheel 220 moves the cutting platform in the Y direction. The cutter controller 50 operatively connects to the motorized wheel 220 to control the Y position of the cutting platform relative to the cutter 40. The illustrated surface features 200 comprise linearly spaced openings (e.g., holes or recesses) in the substrate 205, but may alternatively comprise any other suitable surface features (e.g., teeth, protrusions, extrusions, etc.) that are engageable with a corresponding surface feature 210 (spur gear teeth, extrusions, protrusions, etc.) of the wheel 220. While the illustrated cutting platform 30 is substantially flat, the cutting platform may alternatively comprise a cylindrical wheel that rotates to control the Y position of a work piece.

As shown in FIG. 3, the cutter 40 mounts to the housing 20 to allow relative movement in the X and Z directions. A motorized rack and pinion system 240 drives the cutter 40 in the X direction. The motorized rack and pinion system 240 operatively connects to the cutter controller 50 so that the cutter controller 50 controls the X position of the cutter 40. While a rack and pinion system 240 is illustrated, any other suitable linear drive system may alternatively be used without deviating from the scope of the present invention (e.g., linear actuator, belt/pulley system, etc.).

The cutter 40 may also move in the Y direction relative to the housing, thus avoiding the need for the platform 30 to move in the Y direction. In such an embodiment, the platform 30 may nonetheless be movable in the Y direction between a closed position (similar to that shown in FIG. 1) and an open position (similar to that shown in FIG. 3) to allow an operator to place a work piece on the platform 30 and remove cut patterns from the platform 30. A sensor may sense the closed/open position of the platform 30 and operatively connect to the cutter controller 50. The cutter controller 50 may prevent cutting procedures from starting or continuing if the sensor senses that the platform 30 is not in its closed position.

As shown in FIG. 3, a solenoid 260 selectively moves the cutter 40 in the Z direction to selectively position the cutter 40 in a downward cutting position or an upward stowed position. The cutter controller 50 operatively connects to the solenoid 260 to control the Z position of the cutter 40. While a solenoid 260 is used in the illustrated embodiment to drive the cutter in the Z direction, any other suitable driving mechanism may alternatively be used without deviating from the scope of the present invention.

The motorized wheel 220, rack and pinion system 240, and solenoid 260 enable the cutter controller 50 to control the position of the cutter 40 relative to the cutting platform 30 in all three orthogonal X, Y, and Z directions. The sets of cutting instructions on the memory device 100 include X, Y, and Z instructions that enable the cutter controller 50 to use the cutter 40 to cut desired patterns out of a work piece on the cutting platform 30.

The cutter 40 may optionally be mounted to the solenoid 260 to allow relative rotational movement about the Z axis. A servo-motor or other rotational drive element preferably controls the rotational position of the cutter 40 so that the cutter 40 appropriately aligns with the direction that the cutter 40 is moving in the X-Y plane. The set of cutting instructions for each pattern on the memory device 100 may include rotational instructions for appropriately controlling the rotational position of the cutter 40. Alternatively, the cutter controller 50 may calculate the appropriate cutter 40 rotational position based on the X-Y-Z cutting instructions. Alternatively, there may be no active control of the rotational position of the cutter 40 and the cutter 40 may simply be freely rotatable so that it aligns itself with the cutting direction during cutting in a manner similar to how a castor wheel aligns itself with a rolling direction.

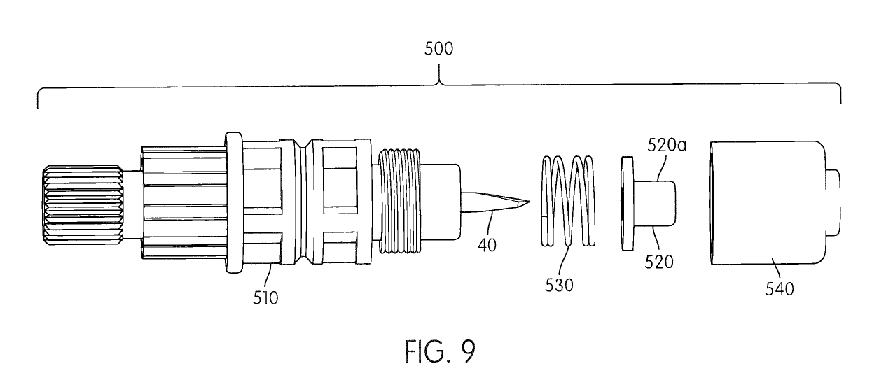

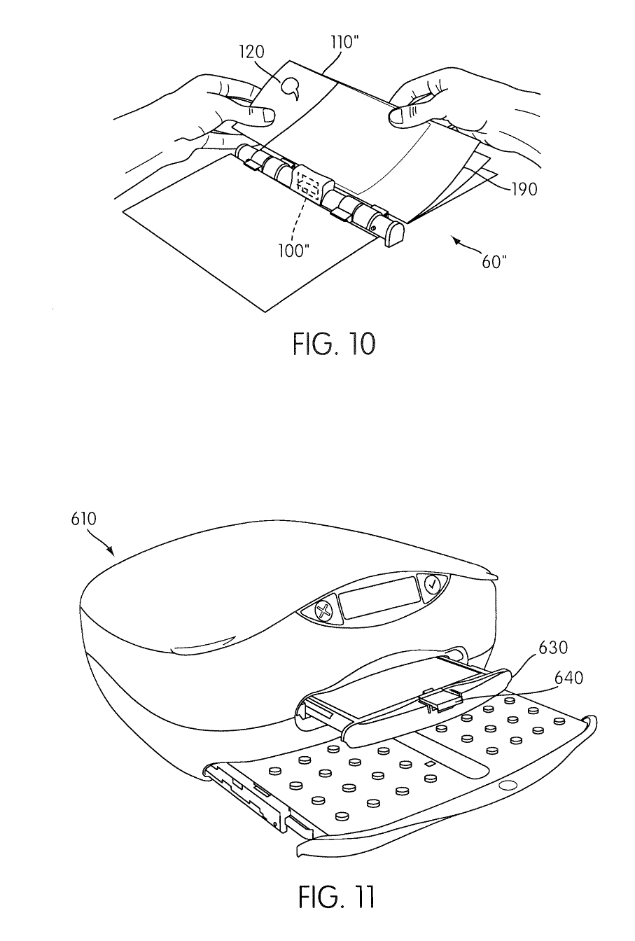

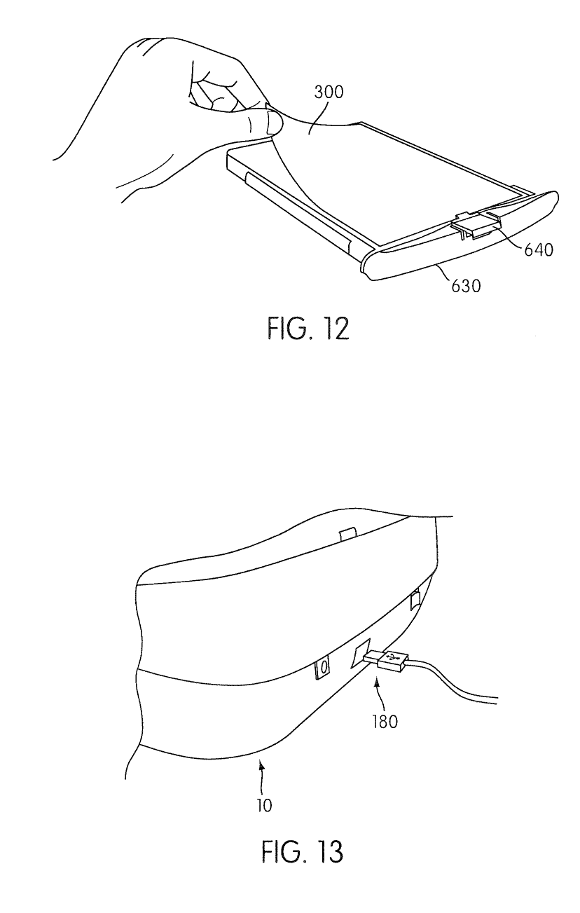

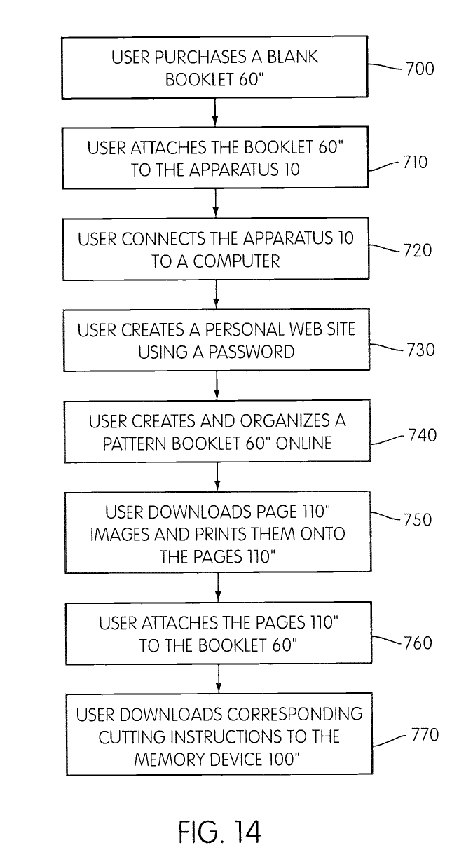

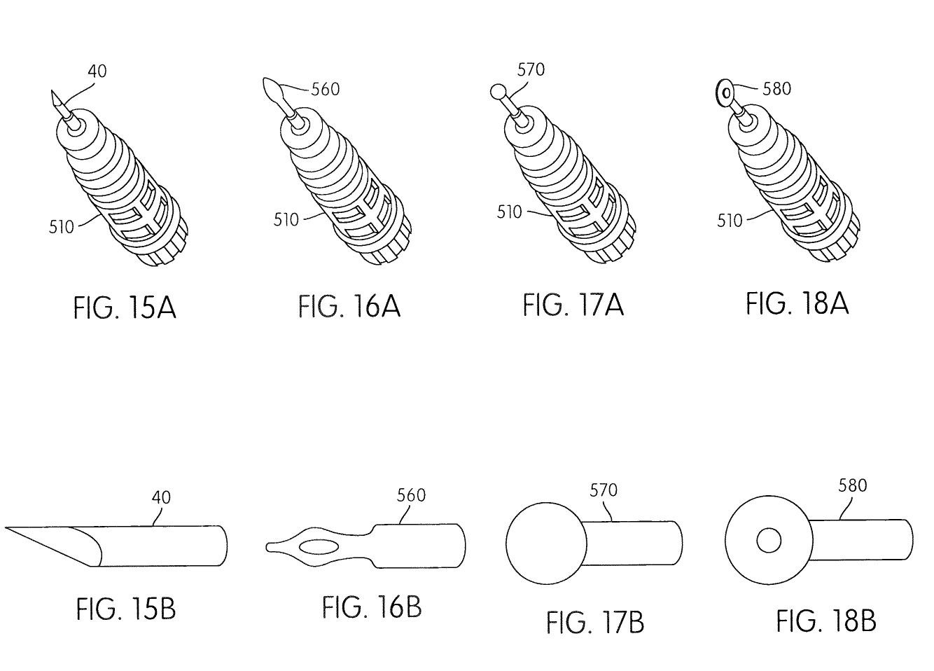

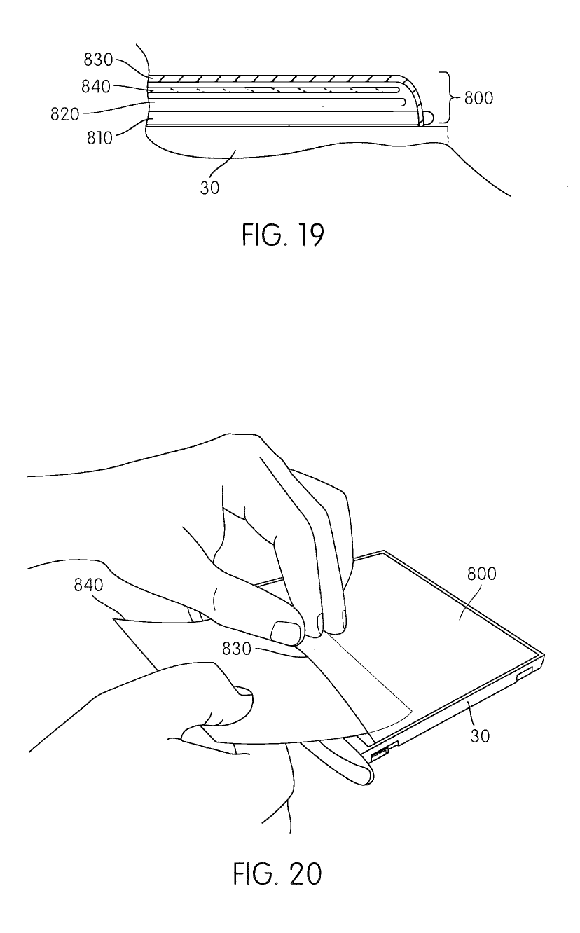

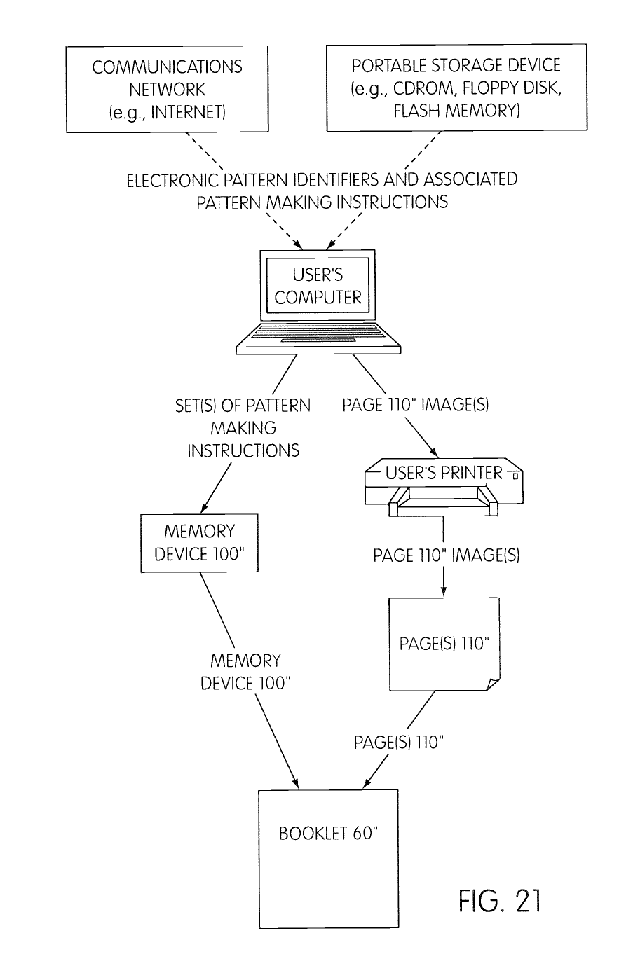

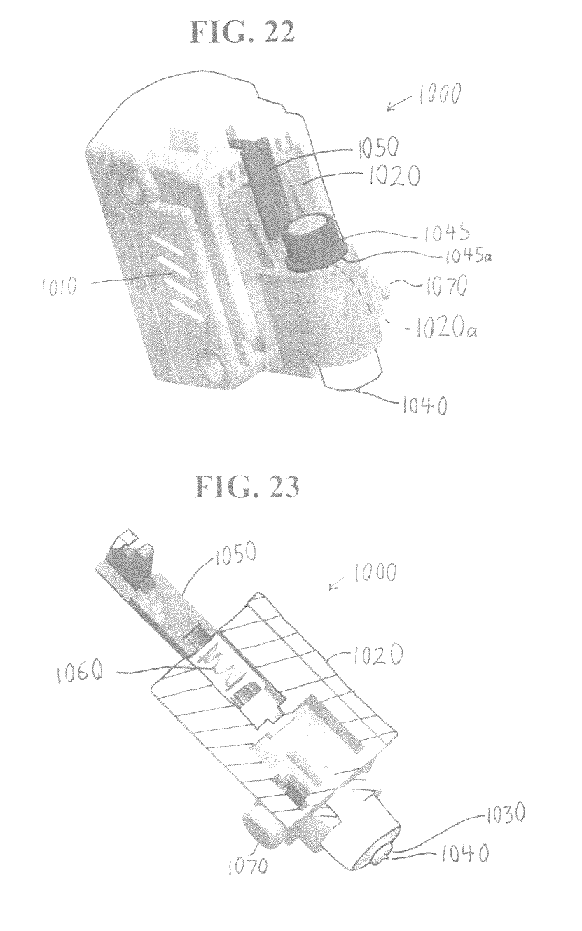

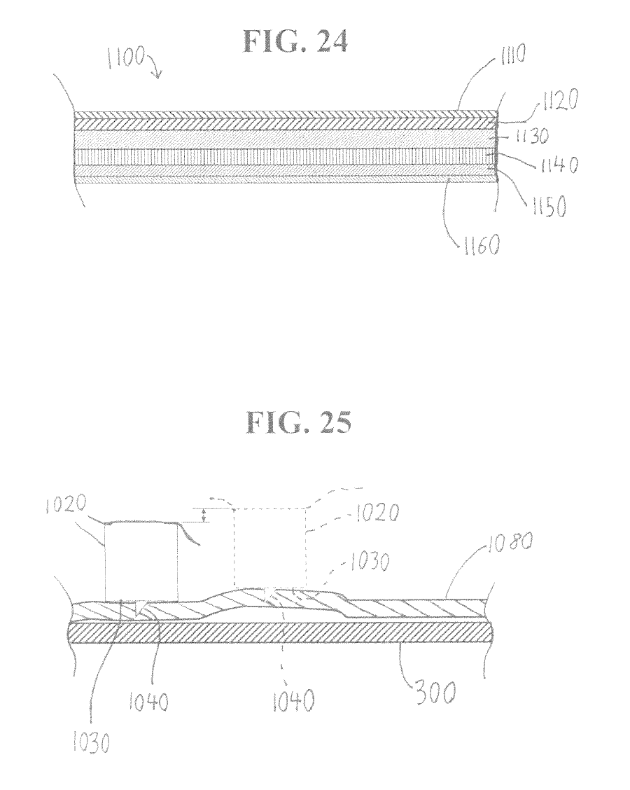

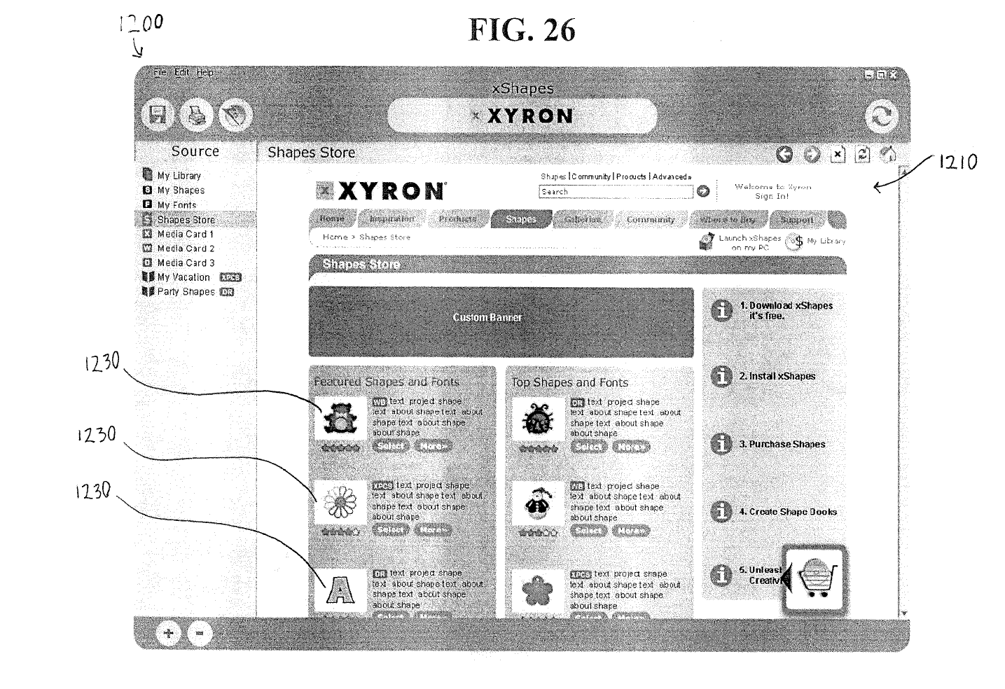

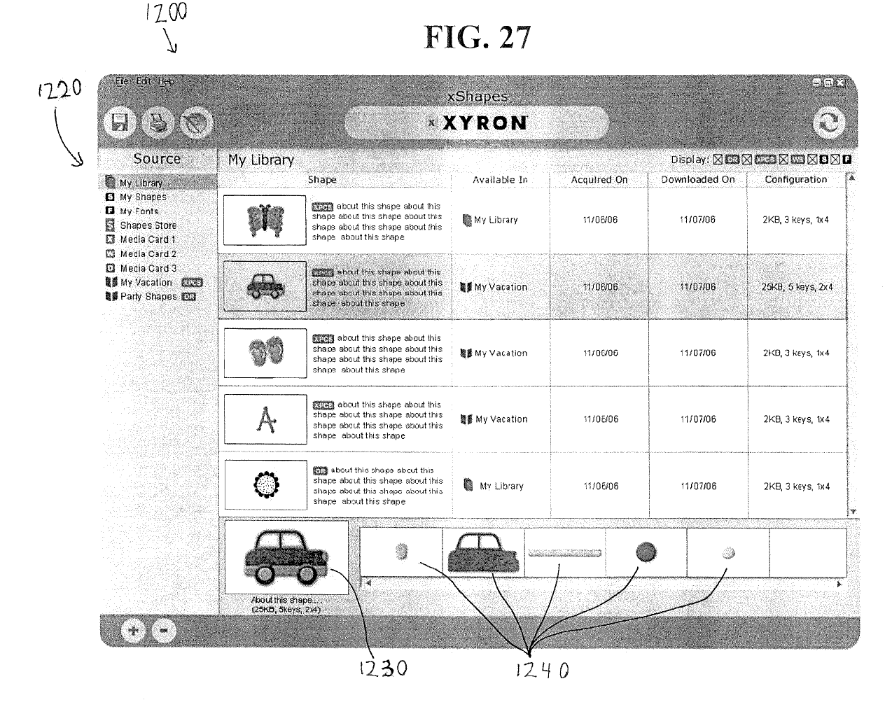

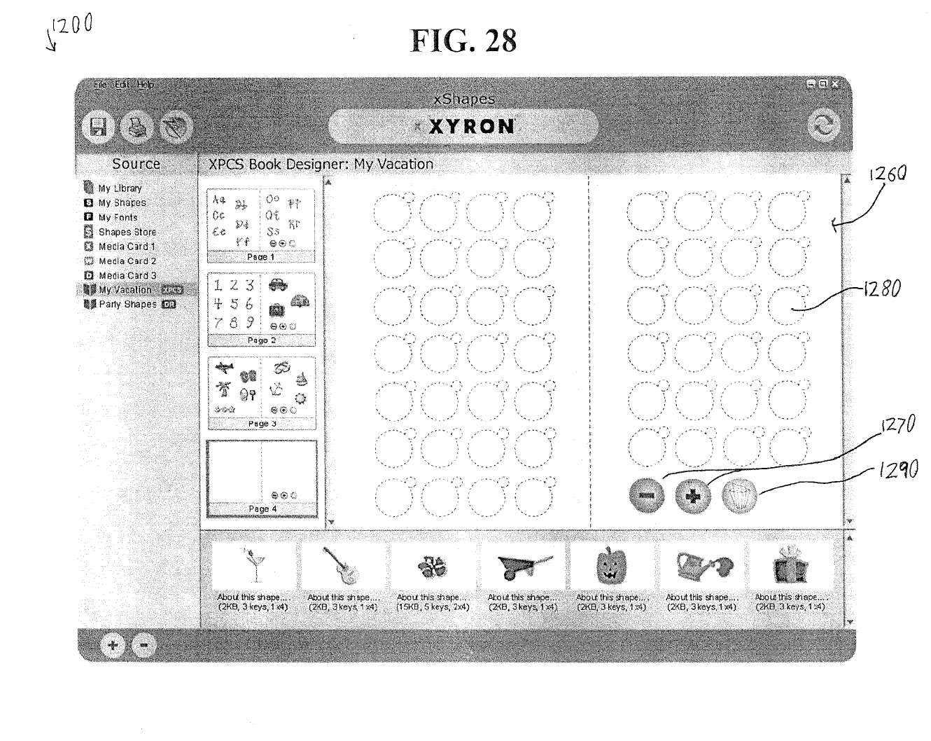

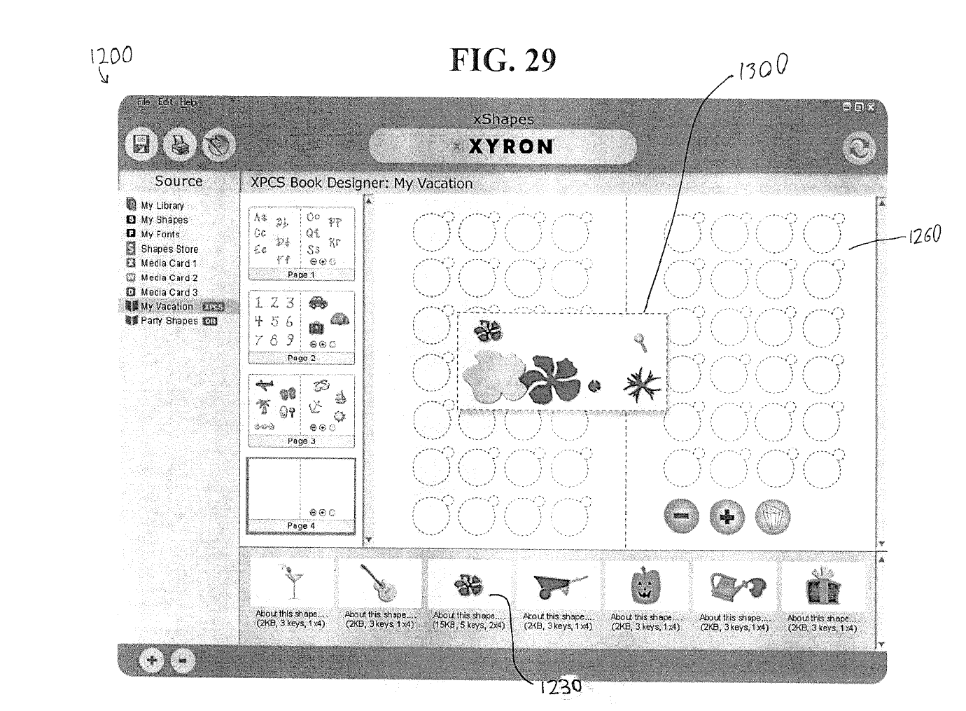

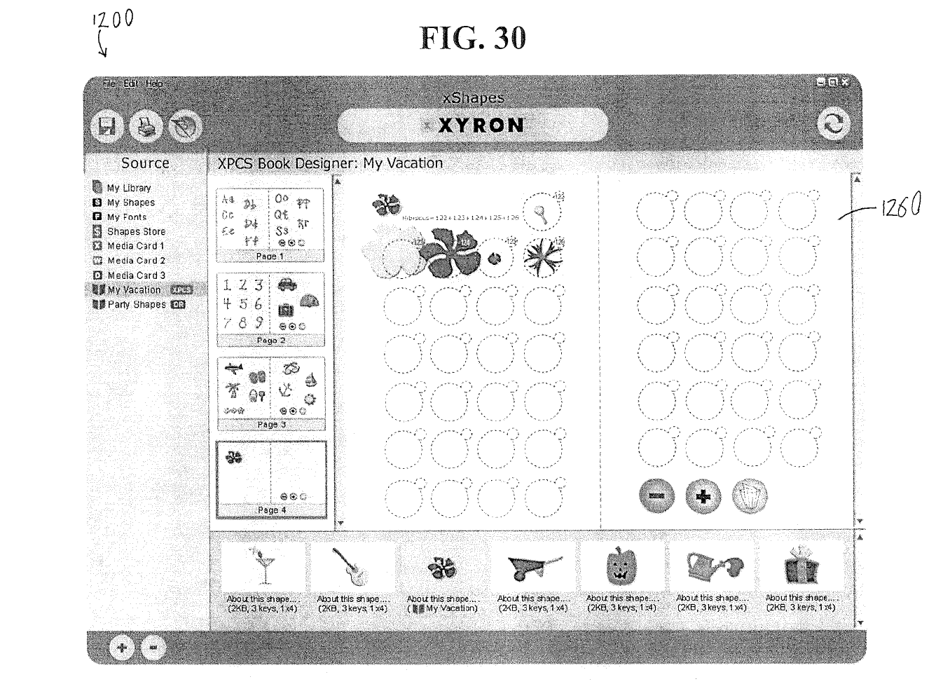

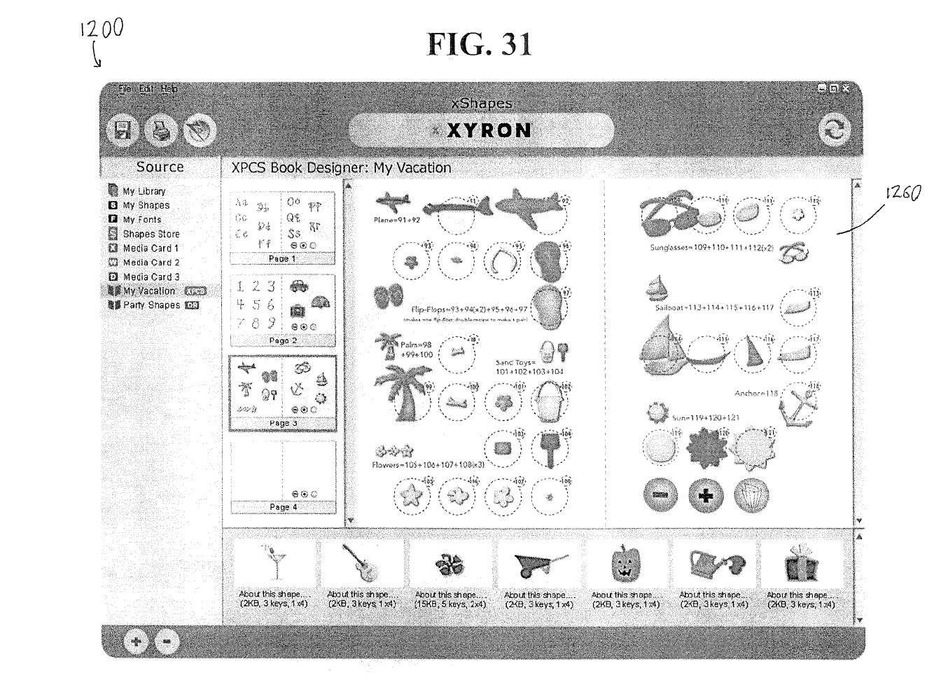

FIG. 9 is an exploded view of a cutting assembly 500 according to an embodiment of the present invention. 40. The cutting assembly 500 includes a base 510 (or pattern making instrument support) that operatively connects to the apparatus 10. The cutter 40 releaseably mounts to the base 510 to facilitate replacement of a worn/dull cutter 40 with a new cutter 40 or an alternative pattern making instrument. The cutter 40 may be held in place via a friction fit or via any suitable positive locking mechanism. A floating cap 520 fits over the cutter 40 and includes a through bore through which the cutter 40 extends. A spring (or other suitable resilient member) 530 is disposed between the floating cap 520 and the base 510 to urge the floating cap 520 away from the base 510 (in a downward direction toward a work piece as shown in FIG. 3). A cap 540 operatively mounts to the base 510 to limit the floating range of the floating cap 520. The cap 540 includes a through bore that is sized to allow a cylindrical portion 520a of the floating cap 520 to fit therethrough while preventing a larger shoulder 520b of the floating cap 520 from extending therethrough. When the apparatus 10 is operated the floating cap 520 pushes down on the work piece to hold the work piece in place during the cutting procedure. The floating cap 520 rises and falls vertically (as shown in FIG. 3) to follow the contour of the work piece, even if the thickness of the work piece varies. The floating cap 520 may be omitted without deviating from the scope of the present invention.

FIGS. 22-23 and 25 illustrate a floating cutter assembly 1000 according to an alternative embodiment of the present invention. The assembly 1000 includes a solenoid 1010 that may mount to the apparatus 10 in place of the solenoid 260 (see FIG. 3). A cutter carrier 1020 movably attaches to the solenoid 1010 for vertical movement relative to the solenoid 1010. The cutter carrier 1020 includes a base 1045 with a work piece contacting surface 1030. A cutter 1040 (or other pattern making instrument) attaches to the base 1045 and extends beyond the work piece contacting surface 1030 by a predetermined distance that is preferably slightly less than, equal to, or slightly larger than a thickness of the work piece so that the cutter 1040 cuts the work piece to a desired depth as the work piece contacting surface 1030 rests against and moves over the work piece 1080. A connector 1050 operatively connects to an actuating pin (not shown) of the solenoid 1010 and to the cutter carrier 1020 via a compression spring 1060 (or other resilient member).

The cutter assembly 1000 may also include a mechanism that enables a user to selectively change a cutting depth (i.e., the predetermined distance by which the cutter 1040 extends beyond the work piece contacting surface 1030) for use with different thickness work pieces. Such a mechanism may control a position of the base 1045 relative to the remainder of the cutter carrier 1020. Alternatively, the fixed cutting depth may be sufficiently large to accommodate the thickness of any anticipated work piece.

A locking mechanism 1070 releaseably locks the base 1045 (and attached cutter 1040) within a hole 1020a in the cutter carrier 1020 to enable a user to selectively remove and replace the base 1045 (and cutter 1040), for example when the cutter 1040 becomes dull or when a different pattern making instrument is used. The base 1045 and cutter 1040 may be replaceable as a unit. Alternatively, the cutter 1040 may be replaceably mounted to the base 1045 such that the base 1045 may be reused with replacement cutters 1040.

In the illustrated embodiment, the locking mechanism 1070 comprises a knob 1070 (or bolt or other threaded fastener) that threads into the cutter carrier 1020 and pins the base 1045 in place within the hole 1020a. The base 1045 may include surface features (e.g., notches, protrusions, extrusions, depressions, etc.) that mate with the knob 1060 to positively lock the base 1045 (and cutter 1040) into a fixed position relative to the cutter carrier 1020 (see, for example, the base 510 in FIG. 15A). In the illustrated embodiment, the base 1045 includes a shoulder 1045a that abuts an annular shoulder of the hole 1020a of the cutter carrier 1020 to provide a positive stop for the base 1045. Alternatively, any other type of suitable locking mechanism may be employed without deviating from the scope of the present invention (e.g., a clamping mechanism that clamps the outer diameter of the cutter 1040).

Operation of the floating cutter assembly 1000 is described with reference to FIGS. 22, 23, and 25. The solenoid 1010 selectively raises and lowers the connecter 1050, cutter carrier 1020, and cutter 1040 in the Z direction between a raised, non-pattern making position and a lowered pattern making position. In one embodiment, the solenoid 1010 has a 3.0 mm stroke. When the cutter 1040 is in the raised position, the cutter 1040 is disposed above the work piece so as not to cut or contact the work piece 1080. When the cutter 1040 is in the lowered position, the spring 1060 partially compresses so as to bias the cutter 1040 and work piece contacting surface 1030 downwardly against the work piece 1080 (shown in FIG. 25). This downward pressure may help to keep the work piece in position during cutting (or other pattern making if other pattern making instrument(s) are used). The cutter carrier 1020 floats upwardly and downwardly against the downward biasing force of the spring 1060 such that the work piece contacting surface 1030 closely follows the upper surface of the work piece 1080, as sequentially illustrated in phantom lines in FIG. 25. When a reaction force of the work piece 1080 against the surface 1030 exceeds the downward force of the spring 1060 (and the weight of the cutter carrier 1020 and cutter 1040), the cutter carrier 1020 and cutter 1040 move upwardly. Consequently, the cutter carrier 1020 and work piece contacting surface 1030 float over irregular contours of the work piece 1080 that might be caused, for example, by bubbles or wrinkles formed between a work piece 1080 and supporting cutting mat 300 or irregularities in the thickness of the work piece 1080 or cutting mat 300. As the cutter carrier 1020 floats over the work piece 1080, the cutter 1040 remains at the predetermined cutting depth relative to an upper surface of the work piece 1080.

The spring constant of the spring 1060 and degree of compression of the spring 1060 when in the lowered position are preferably set such that the downward bias of the spring 1060 keeps the cutter 1040 cutting through the work piece 1080 at the predetermined cutting depth while allowing the cutter carrier 1020 to float over the contours of the upper surface of the work piece 1080.

In one embodiment, the free length of the spring 1060 is 10.00 mm and the spring 1060 has a spring rate or constant of 0.5 Newtons/mm. The spring 1060 may be precompressed by several mm when the cutter carrier 1020 is in the raised position. When the cutter carrier 1020 is in the lowered position and used with relatively thin paper, the spring 1060 compresses by 4.0 mm, which results in a spring force of 2.0 N. When this spring force is combined with the weight of the cutter carrier 1020, spring 1060, and cutter 1040, the cutter assembly 1000 generates a downward force of about 2.5 N. This downward force is sufficiently small to allow the work piece 1080 to force the cutter carrier 1020 and cutter 1040 upwardly over irregularities, bumps, bubbles, etc. in the work piece 1080. When a thicker card stock is used as the work piece 1080, the spring 1060 compresses by 5.0 mm, resulting in a spring force of 2.5 N. According to other embodiments of the present invention, the cutter assembly 1000 is designed to apply to the work piece a downward force of between 0.25 and 15.0 N when in the lowered position. According to still further embodiments of the present invention, the downward force is between 0.5 and 9.0 N, between 0.5 and 8.0 N, between 0.5 and 7.0 N, between 0.5 and 6.0 N, between 0.5 and 5.0 N, between 0.5 and 4 N, between 1.0 and 10.0 N, between 1.0 and 8 N, between 1.0 and 6 N. between 1.0 and 5.0 N, or between 1.0 and 4.0 N. When the upwardly directed reaction force of the work piece 1080 exceeds this downward force (e.g., when the cutter carrier 1020 traverses a bump in the work piece 1080 during a cutting operation), the cutter carrier 1020 and cutter 1040 move upwardly. Conversely, when the reaction force decreases (e.g., when cutter carrier 1020 moves past the bump), the cutter carrier 1020 and cutter 1040 move downwardly to follow the surface of the work piece 1080.

When the cutter carrier 1020 is in the lower position, it preferably has a floating stroke length that is large enough to enable it to float over anticipated irregularities in work pieces, taking into consideration the thickness of such work pieces. According to one embodiment of the present invention, the stroke length is about 3.0 mm. The stroke length according to other embodiments of the present invention may be greater than 0.1 mm, greater than 0.3 mm, greater than 0.5 mm, between 0.1 and 5.0 mm, between 0.5 and 5.0 mm, between 0.5 and 3.0 mm, or about 2.0 mm.

The desired downward force of the cutter assembly 1000 may also be a function of the surface area of the work piece contacting surface 1030 because the combination of force and surface area determines the pressure exerted on the work piece, and, in turn, the upward pressure and force exerted by the work piece onto the cutter carrier 1020. If the surface area of the work piece contacting surface 1030 is relatively large, the desired downward force may be increased accordingly. According to one embodiment of the present invention, the work piece contacting surface 1030 has a surface area of about 20 mm². According to one embodiment, when an average thickness work piece is used, the work piece contacting surface 1030 applies a pressure of about 0.125 N/mm² to the work piece 1080.

The downward force of the cutter assembly 1000 causes the surface 1030 to forcefully contact the work piece 1080, which creates friction that tends to cause the cutter assembly 1000 to resist cutting movement in the X-Y plane relative to the work piece 1080. Similarly, when the cutter carrier 1020 and cutter 1040 encounter irregularities in the work piece 1080 during cutting, the Z-direction downward force of the cutter assembly 1000 further impedes the X-Y movement relative to the work piece 1080. The downward force is therefore preferably limited so that it does not cause the cutter assembly 1000 to bind during cutting operations. To avoid binding, a larger motor/actuator may be used to drive the cutter 1040 and work piece 1080 relative to each other in the X-Y plane. If a larger motor/actuator is impractical or undesired, the downward force may be reduced as much as possible to limit the binding force and allow for the use of weaker, but less expensive, motor(s) to move the cutter 1040 and work piece 1080 relative to each other in the X-Y plane.

In the illustrated embodiment, the downward force is provided by the spring 1060. However, the resilient biasing force may alternatively be provided by any other suitable mechanism. For example, the illustrated solenoid 1010 provides a 3.0 mm stroke based on a large solenoid force. The solenoid 1010 could be modified to weaken its driving force such that its force creates the limited desired resilient downward force. Alternatively, the cutter carrier 1020 and cutter 1040 could be weighted such that their gravitational force provides the desired resilient downward force.

The work piece 1080 is preferably a thin, substantially planar work piece such as paper, cardstock, construction paper, adhesive paper, etc. The cutter 40, 1040 is preferably a paper cutter that is constructed to cut through such a work piece, and may include a blade with a sharp cutting edge.

As shown in FIGS. 3 and 4, the cutting platform 30 includes a cutting mat 300 disposed on a top surface of the rigid substrate 205 of the cutting platform 30. FIG. 4 illustrates a cross-sectional view of the cutting mat 300. The cutting mat 300 comprises a central layer of self-healing material 310, adhesive layers 320 disposed above and below the central self-healing layer 310, and removable protective layers 330 disposed above and below the adhesive layers 310. As used herein, the term “self-healing” means any material that essentially returns to its original shape after being cut. The self-healing layer 310 preferably comprises a self-healing vinyl that may be repeatedly cut by the cutter 40 before it must be replaced. The self-healing layer 310 may alternatively comprise any other suitable resilient material that essentially returns to its original shape after being cut.

The adhesive layers 320 preferably comprise a relatively low tack, high shear resistance adhesive that has a tacky surface that secures the work piece in place relative to the cutting platform 30 during cutting operations, and releases the work piece without damage after cutting. For example, the adhesive layers 320 may comprise a microsphere adhesive or a soft rubber compound. If the adhesive layer 320 comprises a soft rubber compound, the layer 320 may be cleaned if it becomes clogged with debris such as dust, fibers, etc. that adversely affects the adhesive properties of the layer 320.

The adhesive layer 320 presents several advantages over conventional cutting mats. The adhesive layer 320 adheres to the underside of the work piece without obstructing any of the work piece from a cutter. Consequently, the entire area of the work piece may be cut. Conversely, in conventional cutters that clamp a work piece in place, the clamped portions of the work piece cannot be cut, which results in waste and limits the size of cut patterns. The adhesive layer 320 also advantageously securely holds the entire surface area of the work piece so that the work piece will not wrinkle while being cut. Conversely, in conventional cutters that utilize clamps to secure the work piece, portions of the work piece that are not clamped down may wrinkle during cutting. The adhesive layer 320 helps the apparatus 10 cut paper products that do not include a sacrificial backing layer or an additional adhesive, as is frequently required by conventional cutters.

The removable protective layers 330 cover the adhesive layers 320 to discourage debris/contaminants from sticking to the adhesive layers 320 when the apparatus 10 is not being used. Accordingly, the top removable protective layer 330 is removed prior to use of the apparatus 10 and subsequently replaced after the apparatus 10 is used. The bottom removable protective layer 330 may be removed before the substrate 205 is mounted to the mat 300 so that the bottom adhesive layer 330 secures the substrate 205 to the mat 300. After the top adhesive layer 320 loses its tackiness, the mat 300 may be flipped over so that the bottom adhesive layer 320 is used to secure a work piece to the cutting platform 30. When both adhesive layers lose their tackiness, the mat 300 should be replaced with a new mat 300.

While the illustrated mat 300 is double-sided, a single-side mat could alternatively be used without deviating from the scope of the present invention. For example, the bottom adhesive layer 320 and removable protective layer 330 could be omitted to create a single-sided cutting mat.

While a tacky cutting platform 30 is preferred, the cutting platform may alternatively use work piece clamps to clamp a work piece to the cutting platform. Furthermore, any other suitable securing means (e.g., vacuum table, clamping rollers, etc.) may be used to secure the work piece to the cutting platform without deviating from the scope of the present invention.

According to an alternative embodiment of the present invention, a stationary or rigid platform 30, which constitutes a permanent re-usable part of the apparatus, may be replaced by a flexible backing liner of a work piece, which would serve as a disposable platform. For example, the backing liner may be a paper liner for an adhesive-backed work piece or an adhesive-backed paper liner for a non-adhesive-backed work piece. The backing liner may optionally include surface features like the surface features 200 of the platform 30 to help the controller 50 precisely control the Y direction position of the backing liner and work piece.

As shown in FIG. 3, a plurality of registration marks 350 are disposed on the top surface of the mat 300. The registration marks 350 comprise nested rectangles that identify where on the mat 300 variously sized work pieces should be placed. The registration marks 350 also indicate to the operator the size of the work piece to help the operator indicate to the cutter controller 50 the size of the available work piece.

As shown in FIG. 3, sufficient rotation of the spur gear 220 disengages the cutting platform 30 from the apparatus 10 in the Y direction to allow the operator to replace the mat 300, insert a blank work piece, and/or remove cut patterns.

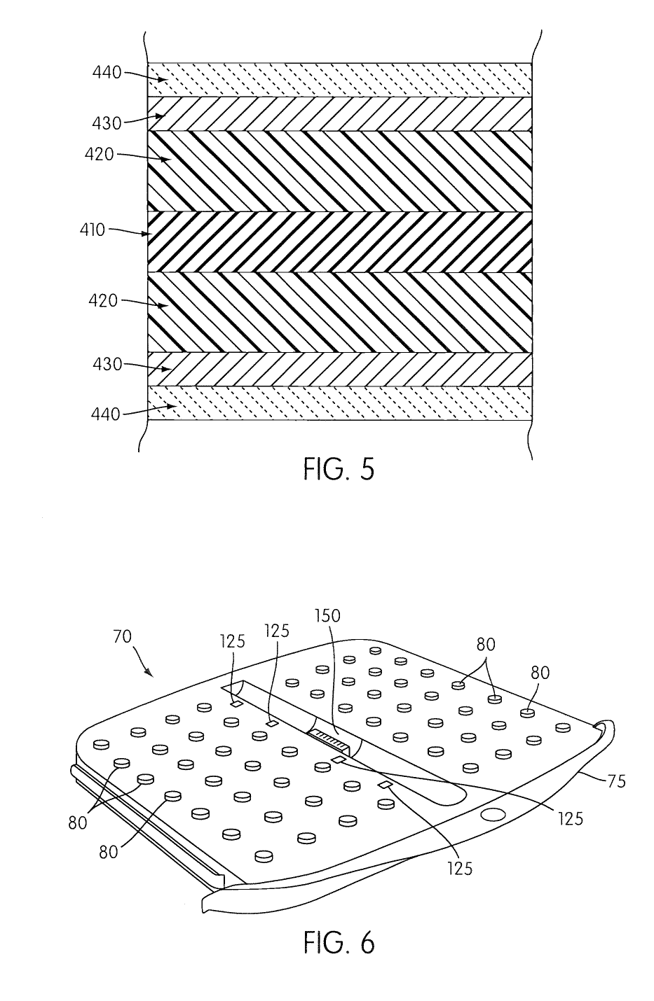

FIG. 5 illustrates a cutting mat 400 according to an alternative embodiment of the present invention. The cutting mat 400 is a two-sided cutting mat that is designed for manual use by an operator with a utility knife or other suitable cutting instrument, but could be used in the apparatus 10 described above. The cutting mat 400 comprises a central rigid substrate 410, upper and lower self-healing layers 420, upper and lower adhesive layers 430, and upper and lower removable protective layers 440. Like the rigid substrate 205 of the cutting platform 30, the central rigid substrate 310 preferably comprises a strong light material such as plastic, that discourages a manual cutting blade from piercing through the entire cutting mat 400. The central rigid substrate 410 is particularly advantageous when an operator is manually cutting a work piece because the cutting blade's depth is not controlled. The self-healing layers 420, adhesive layers 430, and protective layers 440 are similar or identical to the analogous layers of the cutting mat 300. The cutting mat 400 secures a work piece while the operator uses a manual cutting instrument to cut the work piece into a desired pattern. While the illustrated cutting mat 400 is two-sided, the lower self-healing layer 420, lower adhesive layer 430, and lower protective layer 440 may be omitted to create a one-side cutting mat without deviating from the scope of the present invention.

FIG. 24 illustrates a cutting mat 1100 according to an alternative embodiment of the present invention. The cutting mat 1100 is a one-side cutting mat that includes, in sequential order, an upper protective layer 1110, an upper adhesive layer 1120, a self-healing layer 130, a substrate layer 1140, a lower adhesive layer 1150, and a lower protective layer 1160. The mat 1100 may be mounted to the apparatus 10 by peeling off the upper and lower protective layers 1110, 1160 and adhering the mat 1100 to the platform 30 (see FIG. 3) with the lower adhesive layer 1150. The lower adhesive layer 1150 is preferably a high tack, high-shear resistance, repositionable adhesive that firmly, but removably attaches the mat 1100 to the platform 30. When a portion of the mat 1100 becomes worn (e.g., due to repetitive cutting operations in the same area of the mat 1100), the mat 1100 may be repositioned by lifting the mat 1100 away from the platform 30, rotating the mat 1100 about a vertical axis (e.g., by 90 degrees for a square shaped mat 1100 or 180 degrees for a square or rectangular mat 1100), and re-adhering the mat 1100 to the platform 30. A permanent adhesive (not shown) may be used to secure the substrate 1110 and the self-healing layer 1130 together on their adjoining surfaces. Alternatively, they may be bonded by other suitable means, such as by heat sealing.

The upper adhesive layer 1120 preferably has a low tack, high shear resistance repositionable adhesive that is designed to discourage a work piece thereon from slipping (i.e., shearing) relative to the mat 1100, while allowing a user to lift the work piece off of the mat 1100 without damage. The upper adhesive layer 1120 preferably has a lower tack than the lower adhesive layer 1150 so that when a user lifts a work piece off of the mat 1100, the work piece will separate from the mat 1100 while the mat 1100 remains adhered to the platform 30.

To help the user differentiate which surface is to face upwardly, and which is to face downwardly, the layers 1130, 1140 may be colored differently. For example, the self-healing layer 1130, may be white or another opaque color, while the substrate 1140 is transparent. Alternatively, indicia, such as a directional indicator (e.g., the work “up”) may be printed on one or both layers 1130, 1140.

The substrate 1140 is preferably more rigid than the self-healing layer 1130, and may be rigid and hard enough that the mat 1100 may be used as a stand-alone cutting board if a user manually cuts a work piece using a knife. Alternatively, the substrate 1140 may be somewhat flexible (e.g., a plastic sheet or a self-healing vinyl sheet) and rely on the supporting platform 30 for rigidity. The substrate 1140 or the self-healing layer 1130 may be omitted without deviating from the scope of the present invention.

As an alternative, the cutting mat 300, 400, 1100 itself could serve as the platform 30 for the apparatus 10. When the operator wants to replace the mat 300, 400, the cutter controller 50 could be operated to discharge the mat 300, 400, 1100 in the Y direction, and then the replacement mat 300, 400 could be fed back into the apparatus 10. Such a mat 300, 400 could be provided with the surface features 200 for improved control.

The cutter 40 may be interchangeably mounted to the apparatus 10 to allow an operator to easily and quickly replace the cutter 40 with a new, sharp cutter 40.

The cutter 40 may also be interchangeable with other types of pattern making instruments (e.g., an embossing instrument 570 (FIGS. 17A&B), a perforating instrument 580 (FIGS. 18A&B (perforating features being disposed along the circumference of the “pizza cutter” style wheel)), or a journaling instrument 560 (FIGS. 16A&B)), which may be quickly and easily attached to the apparatus 10 in place of the cutter 40 using any suitable releasable holding mechanism. As discussed above, the cutting mat 300 is designed for use with the cutter 40. The cutting mat 300 may be interchangeable with other types of pattern making mats that are better suited to the selected pattern making instrument. A storage compartment may be provided on the apparatus 10 to store the pattern making instruments 40, 570, 580, 560 that are not being used.

If a journaling instrument is used, a mat having a harder, but tacky, upper surface may be used so that the journaling instrument does not pierce the work piece. A journaling mat could be incorporated into the platform 30, so that a journaling instrument could be used by simply removing the mat 300. Alternatively, a replaceable journaling mat could be used. A replaceable journaling mat may be identical to the mat 400 shown in FIG. 5, except without the self-healing layers 420. Accordingly, a two-sided journaling mat could include, in sequential order, a protective layer 440, an adhesive layer 430, a rigid substrate 410, an adhesive layer 430, and a protective layer 440.

Alternatively, a mat could include a cutting mat on one side and a journaling mat on the other side. Such a mat could be identical to the mat 400 shown in FIG. 5, except without one of the relatively soft, self-healing layers 420. A user could simply flip the mat over to switch between mat surfaces designed for cutting and journaling.

If an embossing instrument is used, a user may place a work piece onto the mat 300 and then place a low-friction protective cover such as a thin deformable protective sheet (e.g., a thin plastic sheet) on top of the work piece. The protective sheet reduces friction between the embossing instrument 570 (see FIG. 17) and the work piece so that the instrument 570 embosses the work piece without tearing it. Alternatively, as illustrated in FIGS. 19 and 20, an embossing mat 800 may be placed on the platform 30 to facilitate embossing operations. As shown in FIG. 19, the embossing mat 800 includes a rigid substrate layer 810, a relatively soft, resiliently deformable layer 820 (e.g., foam, soft rubber) attached to or placed on the substrate layer 810, and a low-friction, resiliently deformable protective top layer 830. As shown in FIG. 20, the top layer 830 may be attached to the substrate layer 810 along three sides to create a pocket into which a work piece 840 such as paper may be slid. Alternatively, the top layer 830 may attach to two, one, or no sides of the substrate layer 810 without deviating from the scope of the present invention. An adhesive may be applied to the bottom of the substrate layer 810 to help secure the mat 800 to the platform 30. The resiliently deformable layer 820 may be a self-healing layer similar to the self-healing layer 420 so that the mat 800 may be used as a cutting mat by removing the top layer 830. An adhesive layer like the adhesive layer 320 may be attached to the upper and/or lower surface of the resiliently deformable layer 820 to secure a work piece to the mat 800 and/or secure the resiliently deformable layer 820 to the rigid substrate layer 810.

According to one embodiment of the present invention, the mat 800 may be flipped over for use during journaling procedures. The hardness of the substrate layer 810 facilitates the use of a journaling instrument 560 (see FIG. 16) without deforming the work piece. A tacky adhesive layer may be applied to the bottom surface of the substrate layer 810 to help hold the work piece in place during journaling procedures.

A user selects the appropriate combination of mat and pattern making instrument and attaches both to the apparatus 10 in order to perform the desired pattern making operation. When the user wishes to perform a different type of pattern making operation, the user simply replaces the attached mat and pattern making instrument with the appropriate new combination of mat and pattern making instrument.

FIG. 11 illustrates an apparatus 610, which is generally similar to the apparatus 10. Accordingly, a redundant description of similar features is omitted. The apparatus 610 includes a work piece supporting platform 630, which is generally similar to the platform 30 except that the platform 630 includes a user-operated lock 640 that releaseably locks the platform 630 into its closed/operative position. Sensors (not shown) may prevent the apparatus 610 from initiating pattern making operations unless the platform 630 is in its closed position 630 and/or the lock 640 is in its locked position. As shown in FIG. 12, cutting mats 300 on the platform 630 may be replaced as discussed above with respect to the platform 30. During cutting operations, the work piece is held in a fixed position relative to the apparatus 610, while the cutter assembly (not shown) moves relative to the platform 630 in the X, Y, and Z directions to cut the work piece.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A method of creating a pattern selection system for use with a pattern making apparatus, the method comprising:
obtaining electronic data including (a) image data for a plurality of pattern identifiers, and (b) a plurality of sets of pattern making instructions corresponding to the plurality of pattern identifiers, the sets of pattern making instructions being usable by the pattern making apparatus for making patterns corresponding to the pattern identifiers;
loading the plurality of sets of pattern making instructions onto a memory device readable by the pattern making apparatus; and
applying the plurality of pattern identifiers onto a substrate using the image data, wherein each pattern identifier on the substrate is associated with its corresponding set of pattern making instructions on the memory device.

2. The method of claim 1, wherein obtaining the electronic data comprises using software on a computer to generate the electronic data.

3. The method of claim 1, wherein obtaining the electronic data comprises downloading the image data for the plurality of pattern identifiers over a communication network, and deriving the plurality of sets of pattern making instructions from the image data for the plurality of pattern identifiers.

4. The method of claim 1, wherein obtaining the electronic data comprises downloading the plurality of sets of pattern making instructions, and deriving the image data for the plurality of pattern identifiers from the plurality of sets of pattern making instructions corresponding to the plurality of pattern identifiers.

5. The method of claim 1, wherein obtaining the electronic data comprises downloading the electronic data over a communication network.

6. The method of claim 5, wherein applying the plurality of pattern identifiers onto the substrate comprising permanently applying the plurality of pattern identifiers onto the substrate.

7. The method of claim 6, wherein permanently applying the plurality of pattern identifiers onto the substrate comprising printing, embossing, gluing, etching, stitching, or molding the plurality of pattern identifiers onto the substrate.

8. The method of claim 5, further comprising:
physically assembling the substrate and the memory device.

9. The method of claim 5, wherein the position of each pattern identifier on the substrate associates that pattern identifier with its corresponding set of pattern making instructions on the memory device.

10. The method of claim 5, wherein obtaining the electronic data comprises obtaining the plurality of sets of pattern making instructions and corresponding pattern identifiers from a portable storage device.

11. The method of claim 5, wherein the plurality of sets of pattern making instructions comprise a plurality of pattern cutting instructions.

12. The method of claim 5, further comprising:
operatively connecting the substrate and memory device to a pattern making apparatus for making patterns on a substantially planar work piece, the pattern making apparatus comprising:
a housing;
a work piece supporting platform mounted to the housing, the platform being constructed and arranged to support the substantially planar work piece;
a pattern making instrument constructed to interact with the work piece, the instrument and the platform being movable relative to one another in generally orthogonal X and Y directions, and in a Z direction generally orthogonal to the X and Y directions;
a controller operatively connected to at least one of the instrument and the platform to move the instrument and platform relative to one another in the X, Y, and Z directions; and
an operator interface operatively connected to the controller, the operator interface including a set of switches,
wherein operatively connecting the substrate and memory device to the pattern making apparatus includes:
operatively connecting the memory device to the controller, each set of pattern making instructions being useable by the controller for moving the instrument and platform relative to one another for making a corresponding pattern from the work piece, and
operatively connecting the substrate to the operator interface so that predetermined switches of the operator interface are associated with predetermined pattern identifiers on the substrate and their corresponding sets of pattern making instructions in the memory device.

13. The method of claim 12, wherein operatively connecting the substrate to the operator interface comprises removably overlaying the substrate onto the operator interface such that each of the plurality of pattern identifiers is physically associated with a corresponding switch.

14. The method of claim 13, wherein removably overlaying the substrate onto the operator interface comprises removably overlaying the substrate onto the set of switches.

15. The method of claim 14, wherein each of the plurality of pattern identifiers is positioned over the corresponding switch thereof such that the operator may select a pattern to be made by pushing down on the desired one of the pattern identifiers.

16. The method of claim 12, wherein the pattern making instrument comprises a cutter, an embossing instrument, a scoring instrument, a perforating instrument, or a journaling instrument.

17. The method of claim 16, wherein the pattern making instrument comprises a journaling instrument.

18. The method of claim 12, wherein the controller is capable of scaling the sets of pattern making instructions to vary a size of a pattern formed from the work piece.

19. The method of claim 12, wherein the pattern making apparatus comprises a pattern cutting apparatus, the work piece supporting platform comprises a cutting platform, the pattern making instrument comprises a work piece cutter, the controller comprises a cutter controller, the plurality of sets of pattern making instructions comprise a plurality of sets of cutting instructions, and the cutter controller is constructed and arranged to move the cutter and platform relative to one another to cut a pattern from the work piece

20. The method of claim 19, wherein the operator interface enables the operator to select the set of cutting instructions corresponding to the desired pattern identifier by actuating a corresponding one of the switches.

21. The method of claim 20, wherein operatively connecting the substrate to the operator interface comprises physically overlaying the substrate onto the operator interface such that each of the plurality of pattern identifiers is physically associated with a corresponding switch.

22. The method of claim 5, further comprising:
obtaining further electronic data including (a) image data for a second plurality of pattern identifiers, and (b) a second plurality of sets of pattern making instructions corresponding to the second plurality of pattern identifiers, the second plurality of pattern making instructions being usable by the pattern making apparatus for making patterns corresponding to the second plurality of pattern identifiers;
loading the second plurality of sets of pattern making instructions onto the memory device; and
applying the second plurality of pattern identifiers onto a second substrate using the image data for the second plurality of pattern identifiers, wherein each pattern identifier on the second substrate is associated with its corresponding set of pattern making instructions on the memory device.

23. The method of claim 22, further comprising physically assembling the substrate, second substrate, and memory device together.

24. The method of claim 1, further comprising:
selecting a plurality of pattern identifiers from a collection of available patterns, wherein obtaining the electronic data comprises downloading data associated with the selected plurality of pattern identifiers via a communication network.

25. The method of claim 24, further comprising choosing desired pattern identifiers from the plurality of pattern identifiers for which associated data was downloaded, wherein applying the plurality of pattern identifiers onto the substrate comprises applying the plurality of pattern identifiers associated with the chosen desired pattern identifiers onto the substrate.

26. The method of claim 24, further comprising paying money in exchange for downloading the data associated with the selected plurality of pattern identifiers.

27. The method of claim 24, wherein the downloaded data comprises image data for the selected plurality of pattern identifiers.

28. The method of claim 24, wherein the downloaded data comprises the plurality of sets of pattern making instructions.

29. The method of claim 24, further comprising selecting an order for the selected plurality of pattern identifiers to appear on the substrate, wherein applying the plurality of pattern identifiers onto the substrate comprises applying the plurality of pattern identifiers onto the substrate such that the plurality of pattern identifiers are arranged in the selected order.

30. The method of claim 1, wherein a pattern associated with one of the pattern identifiers comprises a plurality of sub-patterns, and wherein applying the plurality of pattern identifiers onto the substrate comprises applying a plurality of pattern identifiers associated with the plurality of sub-patterns adjacent each other on the substrate.

31. The method of claim 30, further comprising applying onto the substrate adjacent the plurality of sub-patterns indicia identifying the pattern and the sub-patterns that collectively form the pattern.

32. A computer program for creating a pattern selection system for use with a pattern making apparatus, the program comprising:
a library component for storing electronic data associated with an available collection of patterns, the library component being configured to display available patterns and enable a user to select available patterns for inclusion in a pattern selection system;
a layout component configured to graphically simulate a lay out of pattern identifiers associated with the selected patterns;
a memory preparation component configured to transfer pattern making instructions associated with the selected patterns to a memory device; and
a printing component configured to print the layout of pattern identifiers onto a substrate such that the pattern identifiers on the substrate are associated with their corresponding pattern making instructions in the memory device.

33. The program of claim 32, wherein the program is configured to operate on a user's personal computer.

34. The program of claim 32, wherein the program is configured to be run remotely from a user via a communications network.

35. The program of claim 32, wherein at least one portion of the program is configured to be run remotely from a user via a communications network, and wherein at least one portion of the program is configured to operate on a user's personal computer.

36. The program of claim 32, wherein the pattern making instructions comprise pattern cutting instructions.

37. The program of claim 32, wherein the physical position of the pattern identifiers on the substrate associates them with their corresponding sets of pattern making instructions.

38. The program of claim 32, wherein a pattern associated with one of the pattern identifiers comprises a plurality of sub-patterns, and wherein the layout component is configured to position the pattern identifiers associated with the sub-patterns adjacent each other on the layout of pattern identifiers.

39. The program of claim 38, wherein the layout component is configured to position indicia identifying which sub-patterns collectively form the pattern adjacent the pattern identifiers associated with the sub-patterns.

40. The program of claim 32, wherein the layout component enables a user to select an order for the pattern identifiers to be arranged on the layout of pattern identifiers.

41. A computer readable medium comprising a set of computer executable instructions for performing a method of creating a pattern selection system for use with a pattern making apparatus, the method comprising:
obtaining electronic data including (a) image data for a plurality of pattern identifiers, and (b) a plurality of sets of pattern making instructions corresponding to the plurality of pattern identifiers, the sets of pattern making instructions being usable by the pattern making apparatus for making patterns corresponding to the pattern identifiers;
loading the plurality of sets of pattern making instructions onto a memory device readable by the pattern making apparatus; and
applying the plurality of pattern identifiers onto a substrate using the image data, wherein each pattern identifier on the substrate is associated with its corresponding set of pattern making instructions on the memory device.

42. The computer readable medium of claim 41, wherein obtaining the electronic data comprises downloading electronic information over a communication network.

43. The computer readable medium of claim 41, wherein the plurality of sets of pattern making instructions comprise a plurality of sets of pattern cutting instructions.

44. The computer readable medium of claim 41, wherein applying the plurality of pattern identifiers onto the substrate comprising permanently applying the plurality of pattern identifiers onto the substrate.

45. The computer readable medium of claim 41, wherein the position of each pattern identifier on the substrate associates that pattern identifier with its corresponding set of pattern making instructions on the memory device.

46. The computer readable medium of claim 41 wherein the method further comprises selecting an order for the selected plurality of pattern identifiers to appear on the substrate, and wherein applying the plurality of pattern identifiers onto the substrate comprises applying the plurality of pattern identifiers onto the substrate such that the plurality of pattern identifiers are arranged in the selected order.

47. The computer readable medium of claim 41, wherein a pattern associated with one of the pattern identifiers comprises a plurality of sub-patterns, and wherein applying the plurality of pattern identifiers onto the substrate comprises applying a plurality of pattern identifiers associated with the plurality of sub-patterns adjacent each other on the substrate.

48. The computer readable medium of claim 41, wherein the method further comprises applying onto the substrate adjacent the plurality of sub-patterns indicia identifying the pattern and the sub-patterns that collectively form the pattern.

49. A pattern cutting apparatus for cutting patterns out of a substantially planar work piece, the apparatus comprising:
a housing;
a platform supported by the housing;
a cutting mat supported by the platform, the cutting mat having
a substrate,
a first adhesive layer disposed between the substrate and the platform, the first adhesive layer releasably mounting the cutting mat to the platform to enable the cutting mat to be detached from and repositioned relative to the apparatus, and
a second adhesive layer disposed on an opposite side of the substrate from the platform, the second adhesive layer being constructed and arranged to hold the work piece in a fixed position relative to the substrate while a pattern is cut from the work piece, the second adhesive layer being formed of a repositionable adhesive for releasing the work piece without damage after cutting;
a cutter supported by the housing, the cutter and cutting mat being movable relative to one another in three orthogonal directions; and
a controller operatively connected to at least one of the cutter and cutting mat to move the cutter and cutting mat relative to one another in the three orthogonal directions.

50. The pattern cutting apparatus of claim 49, wherein the first adhesive layer has a higher tack than the second adhesive layer.

51. The pattern cutting apparatus of claim 49, further comprising a protective layer removably attached to an exposed surface of the second adhesive layer.

52. The pattern cutting apparatus of claim 49, wherein the substrate comprises vinyl.

53. The pattern cutting apparatus of claim 49, wherein the substrate comprises plastic.

54. The pattern cutting apparatus of claim 49, wherein the cutting mat includes at least one registration mark for guiding the placement of the work piece thereon.

55. A work piece supporting mat for securing a substantially planar work piece while making one or more patterns from the work piece, the mat comprising:
a substrate;
an upper adhesive layer mounted to the substrate, the upper adhesive layer being formed of a repositionable adhesive for releasably holding the work piece in a fixed position thereon while a pattern is made from the work piece;
an upper protective layer removably attached to an exposed surface of the upper adhesive layer;
a lower adhesive layer mounted to the substrate, the lower adhesive layer being a repositionable adhesive for releasably holding the mat in a fixed position on a surface against which the mat is mounted; and
a lower protective layer removably attached to an exposed surface of the lower adhesive layer.

56. The work piece supporting mat of claim 55, wherein the lower adhesive layer has a higher tack than the upper adhesive layer.

57. The work piece supporting mat of claim 55, further comprising a self-healing layer disposed between the substrate and the upper adhesive layer.

58. The work piece supporting mat of claim 55, wherein the substrate comprises vinyl.

59. A pattern cutting apparatus for cutting patterns out of a substantially planar work piece, the apparatus comprising:
a housing;
a cutting mat supported by the housing, the cutting mat having
a substrate;
a self-healing layer disposed on the substrate, and
an adhesive layer disposed on the self-healing layer, the adhesive layer being constructed and arranged to hold the work piece in a fixed position relative to the substrate while a pattern is cut from the work piece, the adhesive layer being formed of a repositionable adhesive for releasing the work piece without damage after cutting;
a cutter supported by the housing, the cutter and cutting mat being movable relative to one another in three orthogonal directions; and
a controller operatively connected to at least one of the cutter and cutting mat to move the cutter and cutting mat relative to one another in the three orthogonal directions.

60. A work piece supporting mat for securing a substantially planar work piece while making one or more patterns from the work piece, the mat comprising:
a layer of self-healing material having upper and lower surfaces;
an adhesive layer disposed on the upper surface of the self-healing material, the adhesive layer being a repositionable adhesive for releasably holding the work piece in a fixed position thereon while a pattern is made from the work piece; and
a removable protective layer disposed on the adhesive layer to protect the adhesive layer when the mat is not being used, wherein the protective layer is removable to expose the adhesive layer to permit the work piece to be fixed thereto.

61. The mat of claim 60, wherein the self-healing layer comprises vinyl.

62. The mat of claim 60, wherein the adhesive layer is constructed and arranged to releasably support a paper work piece.

63. The mat of claim 60, wherein the adhesive layer comprises one of a soft rubber and a microsphere adhesive.

64. The mat of claim 60, further comprising:
a second adhesive layer disposed on the lower surface of the self-healing layer; and
a second removable protective layer disposed on the second adhesive layer to protect the second adhesive layer when the second adhesive layer is not being used to hold the work piece.

65. The mat of claim 64, further comprising a second adhesive layer disposed on the lower surface of the self-healing layer, wherein the second adhesive layer comprises a higher tack adhesive than the adhesive layer.

66. The mat of claim 60, further comprising a rigid substrate having an upper surface, wherein the layer of self-healing material is disposed on the upper surface of the rigid substrate.

67. The mat of claim 66, wherein the rigid substrate comprises plastic.

68. The mat of claim 66, wherein the rigid substrate has a lower surface, and wherein the mat further comprises:
a second layer of self-healing material disposed on the lower surface of the rigid substrate;
a second adhesive layer disposed on the second layer of self-healing material; and
a second removable protective layer disposed on the second adhesive layer to protect the second adhesive layer when the second adhesive layer is not being used to hold the work piece.

69. A pattern cutting apparatus for cutting patterns out of a substantially planar work piece, the apparatus comprising:
a housing;
a work piece supporting platform;
a cutter assembly supported by the housing, the cutter assembly comprising
a cutter carrier having a work piece contacting surface, the cutter carrier being resiliently biased toward the platform for maintaining the work piece contacting surface in contact with the work piece and for enabling the cutter carrier to move upwardly when the work piece contacting surface engages raised portions of the work piece, and
a cutter extending beyond the work piece contacting surface by a predetermined distance, the cutter assembly and platform being movable relative to one another in three orthogonal directions; and
a controller operatively connected to at least one of the cutter assembly and platform to move the cutter assembly and platform relative to one another in the three orthogonal directions.

70. The pattern cutting apparatus of claim 69, wherein the cutter assembly further comprises a resilient member that biases the cutter carrier toward the platform.

71. The pattern cutting apparatus of claim 69, wherein the cutter carrier is positioned and arranged such that cutter carrier and cutter move away from the platform in response to a predetermined force being applied to the work piece contacting surface and cutter.

72. The pattern cutting apparatus of claim 71, wherein the cutter carrier is positioned and arranged such that cutter carrier and cutter move away from the platform by at least 0.1 mm in response to the predetermined force being applied to the work piece contacting surface and cutter.

73. The pattern cutting apparatus of claim 71, wherein the predetermined force is less than 15.0 N.

74. The pattern cutting apparatus of claim 73, wherein the predetermined force is less than 10.0 N.

75. The pattern cutting apparatus of claim 74, wherein the predetermined force is less than 8.0 N.

76. The pattern cutting apparatus of claim 75, wherein the predetermined force is less than 6.0 N.

77. The pattern cutting apparatus of claim 76, wherein the predetermined force is less than 5.0 N.

78. The pattern cutting apparatus of claim 77, wherein the predetermined force is less than 4.0 N.

79. The pattern cutting apparatus of claim 78, wherein the predetermined force is less than 3.0 N.

80. The pattern cutting apparatus of claim 73, wherein the controller comprises a linear actuator that operatively extends between the housing and the cutter carrier to selectively move the cutter carrier between cutting and non-cutting positions, and wherein the resilient member operatively extends between the linear actuator and the cutter carrier for biasing the cutter carrier toward the platform when the cutter carrier is in the cutting position.
